(19) United States
(12) Patent Application Publication
(10) Pub. No.: US 2021/0127225 A1
(43) Pub. Date: Apr. 29, 2021

(54) COMPLEX GEOFENCE DEFINITION

(71) Applicant: HERE Global B.V., Eindhoven (NL)

(72) Inventors: Mika VIITALA, Tampere (FI); Marko LUOMI, Tampere (FI)

(73) Assignee: HERE Global B.V., Eindhoven (NL)

(21) Appl. No.: 17/058,534

(22) PCT Filed: May 28, 2018
(86) PCT No.: PCT/EP2018/063944

§ 371 Date: Nov. 24, 2020

(51) Int. Cl. H04W 4/021

(52) U.S. Cl. CPC H04W 4/021

(57) ABSTRACT

It is inter-alia disclosed a method performed by an apparatus, said method comprising receiving a representation of a geofence for each geofence of one or more geofences from a server via a network, wherein the representation of a geofence comprises a set of sub-geofences, and wherein the sub-geofences of a set of sub-geofences represent splitted components of the geofence associated with the set of sub-geofences.

### FIELD OF THE DISCLOSURE

The invention relates to the field of geofences, and in particular to complex geofences.

### BACKGROUND

The number of devices with location capabilities is expected to grow exponentially in the next decade or so. This growth is the result of the Internet-of-Things -era (IoT), in which more and more devices get connected to the Internet. Soon homes, factories, cities and transportation means will be equipped with low-cost sensors that produce real-time information on various characteristics and environment variables. Moreover, the cheaper electronics enables factories and industries to equip assets and supply chains with trackers that provide real-time information on the flow of goods.

The basic ingredient of the IoT story is that the sensors and trackers are location-aware. The location-awareness can be achieved through two means: either the device has its own positioning capabilities (like GNSS or cell/wifi/Bluetooth offline positioning) or the device makes measurements of the radio environment (cell/wifi/Bluetooth) and sends them to the cloud for position determination or performs positioning based on a radio map locally stored at the device, wherein said positioning may be an offline positioning. Radiomap is a map that relates identification, signal strength or any other parameter of radio access point like cellular base station, wi-fi access point or distribution of such a parameter to a real word location e.g. latitude, longitude and altitude.

When it comes to small devices that must function autonomously for extended periods of time, power consumption is of special concern. The devices are powered by batteries and, thus, any means to reduce current drain are welcome. As far as location technologies are concerned, there are few ways to reduce power consumption. The greatest power saving results from using the correct technology at the correct time. To exemplify, when low location accuracy is adequate, it is advantageous to use cellular positioning, because it is cheap in terms of energy.

Location is important not only for simple tracking use cases, but also for event notifications. Specifically, when events are tied to geographical constraints, one talks about geofences. A geofence may, for example, be a polygon. When the device enters (or leaves) the defined area, an observer may get notified about the event. While geofences are powerful tools, they may also consume a lot of power. Thus, also in such use cases the correct choice of technology is of essence.

Thus, when tracking people or objects based on their location geofencing is often used to trigger different events such as notifications. Geofences are typically circles or complex polygons. From power consumption point of view, it is often beneficial to calculate the position of the device as well as the estimate whether the device is inside the geofence or not locally in the device.

### SUMMARY OF SOME EMBODIMENTS OF THE INVENTION

According to an exemplary embodiment of a first aspect of the invention, a method is disclosed, wherein the method comprises receiving a representation of a geofence for each geofence of one or more geofences from a server via a network, wherein the representation of a geofence comprises a set of sub-geofences, and wherein the sub-geofences of a set of sub-geofences represent splitted components of the geofence associated with the set of sub-geofences.

This method may for instance be performed and/or controlled by an apparatus, for instance by a mobile device.

According to a further exemplary embodiment of the first aspect of the invention, a computer program is disclosed, the computer program when executed by a processor causing an apparatus to perform and/or control the actions of the method according to the exemplary embodiment of the first aspect of the present invention.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary embodiment of the first aspect of the invention, an apparatus (e.g. the first apparatus) is disclosed, configured to perform and/or control or comprising respective means for performing and/or controlling the method according to the exemplary embodiment of the first aspect of the present invention.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary embodiment of the first aspect of the invention, an apparatus is disclosed, comprising at least one processor and at least one memory including computer program code, the at least one memory and the computer program code configured to, with the at least one processor, cause an apparatus, for instance the apparatus, at least to perform and/or to control the method according to the exemplary embodiment of the first aspect of the present invention.

The above-disclosed apparatus according to the first aspect of the invention may be a module or a component for a device, for example a chip. Alternatively, the disclosed apparatus according to any aspect of the invention may be a device, for instance a gateway device. The disclosed apparatus according to any aspect of the invention may comprise only the disclosed components, for instance means, processor, memory, or may further comprise one or more additional components.

According to an exemplary embodiment of a second aspect of the invention, a method is disclosed, wherein the method comprises causing the transmission of a representation of a geofence for each geofence of one or more geofences of a set of at least one geofence to a second apparatus via a network, wherein the representation of a geofence comprises a set of sub-geofences, and wherein the sub-geofences of a set of sub-geofences represent splitted components of the geofence associated with the set of sub-geofences. For instance, said second apparatus may be apparatus according to the first aspect of the invention.

The method according to the second aspect of the invention may for instance be performed and/or controlled by at least one apparatus, wherein this at least one apparatus may be a server, e.g. the server from which a representation of a geofence for each geofence of one or more geofences is received from a server via a network according to the first aspect of the invention.

According to a further exemplary embodiment of the second aspect of the invention, a computer program is disclosed, the computer program when executed by a processor causing an apparatus to perform and/or control the actions of the method according to the exemplary embodiment of the second aspect of the present invention.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary embodiment of the second aspect of the invention, at least one apparatus (e.g. the first apparatus) is disclosed, configured to perform and/or control or comprising respective means for performing and/or controlling the method according to the exemplary embodiment of the second aspect of the present invention.

The means of the apparatus can be implemented in hardware and/or software. They may comprise for instance at least one processor for executing computer program code for performing the required functions, at least one memory storing the program code, or both.

Alternatively, they could comprise for instance circuitry that is designed to implement the required functions, for instance implemented in a chipset or a chip, like an integrated circuit. In general, the means may comprise for instance one or more processing means or processors.

According to a further exemplary embodiment of the second aspect of the invention, an apparatus is disclosed, comprising at least one processor and at least one memory including computer program code, the at least one memory and the computer program code configured to, with the at least one processor, cause an apparatus, for instance the apparatus, at least to perform and/or to control the method according to the exemplary embodiment of the second aspect of the present invention.

The above-disclosed apparatus according to second aspect of the invention may be a module or a component for a device, for example a chip. Alternatively, the disclosed apparatus according to any aspect of the invention may be a device, for instance a gateway device. The disclosed apparatus according to any aspect of the invention may comprise only the disclosed components, for instance means, processor, memory, or may further comprise one or more additional components.

In the following, exemplary features and exemplary embodiments of all aspects of the present invention will be described in further detail.

According to an exemplary embodiment of all aspects of the present invention, a sub-geofence of a set of sub-geofences has less geometrical complexity compared to the geometrical complexity of the geofence associated with the set of sub-geofences.

According to an exemplary embodiment of all aspects of the present invention, the geofence associated with a set of sub-geofences is defined at least partially based on a polygon of order m, and wherein a sub-geofence of the set of sub-geofences associated with the geofence is defined by a polygon of order n, with n <m.

According to an exemplary embodiment of all aspects of the present invention, at least one sub-geofence or each sub-geofence of a set of sub-geofences of a representation of the geofence is defined by a triangle.

According to an exemplary embodiment of all aspects of the present invention, each geofence of the at least one geofence of the one or more geofences (or of the at least one geofence) is represented by a polygon and each sub-geofence of the set of sub-geofences of this geofences is represented by a triangle, wherein each triangle of the set of sub-geofences fulfills the Delaunay triangulation criteria, i.e., no point in P of the polygon of the geofence is inside the circumcircle of any triangle of the sub-geofences of the represenation of this geofence.

According to an exemplary embodiment of all aspects of the present invention, the sub-geofences of a set of sub-geofences do not overlap with each other.

According to an exemplary embodiment of the first aspect of the present invention, it is comprised receiving a radiomap from a server via the network, wherein, in particular receiving a representation of a geofence for each geofence of one or more geofences from a server via a network and said receiving a radiomap from the server via the network is performed during a same transmission session. For instance, a radiomap is a map that relates identification, signal strength or any other parameter of radio access point like cellular base station, wi-fi access point or distribution of such a parameter to a real word location e.g. latitude, longitude and altitude

According to an exemplary embodiment of all aspects of the present invention, the radiomap is an offline radiomap.

According to an exemplary embodiment of all aspects of the present invention, the at least one representation of a geofence is within an area defined by the radio map.

According to an exemplary embodiment of the first aspect of the present invention, it is comprised, before said receiving a representation of a geofence for each geofence of one or more geofences from a server via a network, causing the transmission of a geofence request to the server via the network, wherein, in particular, the geofence request comprises at least one parameter, and wherein the at least one parameter comprises a location information and/or an information regarding storage size.

According to an exemplary embodiment of the first aspect of the present invention, it is comprised checking whether a location of the apparatus is within a geofence defined by a representation of a geofence of the one or more geofences.

According to an exemplary embodiment of the first aspect of the present invention, said checking whether a location of the apparatus is within a geofence defined by a representation of a geofence of the one or more geofences comprises checking if the location is within in a sub-geofence of the set of sub-geofences associated with the geofence.

According to an exemplary embodiment of the first aspect of the present invention, said checking whether a location of the apparatus is within a geofence defined by a representation of a geofence of the one or more geofences is performed based on barycentric coordinates.

According to an exemplary embodiment of the first aspect of the present invention, it is comprised determining the location based on a radio map, in particular said radio map received from a server via the network.

According to an exemplary embodiment of all aspects of the present invention, said set of sub-geofences of a representation of a geofence for each geofence of the one or more geofences of the set of at least one geofence is associated with a first layer, and wherein for each geofence of at least one geofence of the one or more geofences the geofence is associated with at least one further layer, wherein each layer of the at least one further layer associated with the geofence comprises a set of sub-geofences being at least partially nested with the set of sub-geofences of the first layer associated with the geofence; wherein, in particular, each layer of the at least one further layer associated with the geofence is part of the representation of a geofence.

According to an exemplary embodiment of all aspects of the present invention, a set of sub-geofences associated with a further layer of a geofence is associated with a different action compared to an action associated with the set of sub-geofences associated with the first layer of the geofence.

According to an exemplary embodiment of the first aspect of the present invention, it is comprised checking whether a location of the second apparatus is within a geofence defined by a set of sub-geofences associated with a further layer of a geofence of the one or more geofences, and, in particular, causing an action associated with the set of sub-geofences associated with a further layer, in particular, if at least one predefined threshold is exceeded.

According to an exemplary embodiment of the second aspect of the present invention, it is comprised, for each geofence of at least one geofence of the set of at least one geofence (e.g. for each geofence of the set of at least one geofence): determining the set of sub-geofences of the representation of the respective geofence.

According to an exemplary embodiment of the second aspect of the present invention, wherein said determining the set of sub-geofences of the representation of the respective geofence comprises splitting the respective geofence into a set of polygons, wherein the set of polygons represent the set of sub-geofences of the representation of the geofence.

According to an exemplary embodiment of the second aspect of the present invention, wherein said splitting is performed based on a Delaunay triangulation.

According to an exemplary embodiment of the second aspect of the present invention, said set of sub-geofences of a representation of a geofence for each geofence of the one or more geofences of the set of at least one geofence is associated with a first layer, and wherein for each geofence of at least one geofence of the one or more geofences the geofence is associated with at least one further layer, wherein each layer of the at least one further layer associated with the geofence comprises a set of sub-geofences being at least partially nested with the set of sub-geofences of the first layer associated with the geofence; wherein, in particular, each layer of the at least one further layer associated with the geofence is part of the representation of a geofence.

According to an exemplary embodiment of the second aspect of the present invention, a set of sub-geofences associated with a further layer of a geofence is associated with a different action compared to an action associated with the set of sub-geofences associated with the first layer of said geofence.

According to an exemplary embodiment of the second aspect of the present invention, it is comprised, for each geofence of at least one geofence of the set of at least one geofence, and for each layer of a further layer associated with the respective geofence: (i) determining a set of sub-geofences being at least partially nested with the set of sub-geofences of the first layer associated with the respective geofence; and, in particular, (ii) associating a different action to the determined set of sub-geofences compared to an action associated with the set of sub-geofences associated with the first layer the respective geofence.

According to an exemplary embodiment of the second aspect of the present invention, wherein said determining a set of sub-geofences associated with the further layer of the respective geofence is performed based on introducing at least one extra point inside and/or outside an area defined by the respective geofence, wherein, in particular, said determining is performed based on a Delaunay triangulation.

According to an exemplary embodiment of the second aspect of the present invention, it is comprised, for each geofence of the set of at least one geofence: (i) determining the respective geofences based on a user interaction, and, in particular, (ii) associating at least one action with the respect geofence based on the user interaction.

According to an exemplary embodiment of the second aspect of the present invention it is comprised causing the transmission of a radiomap to the second apparatus via the network, wherein, in particular said transmission of a representation of a geofence for each geofence of one or more geofences of the set of at least one geofence to the second apparatus via a network and said transmission of a radiomap to the second apparatus via a network is performed during a same transmission session.

According to an exemplary embodiment of the second aspect of the present invention, it is comprised, before causing said transmission of a representation of a geofence for each geofence of one or more geofences of a set of at least one geofence to a second apparatus via a network: (i) receiving a geofence request from the second apparatus via the network, and (ii) determining the one or more geofences from the set of at least one geofence.

According to an exemplary embodiment of all aspects of the present invention, the geofence request comprises at least one parameter, and wherein the at least one parameter comprises a location information and/or an information regarding storage size, and wherein said determining the one or more geofences from the set of at least one geofence is performed based on the at least one parameter.

According to an exemplary embodiment of the second aspect of the present invention, said radio map caused to be transmitted to the second apparatus via the network is determined from a second radio map, in particular based on the geofence request.

According to an third aspect of the present invention, a system is disclosed , comprising: (i) a first apparatus according to the second aspect of the invention, (ii) at least one second apparatus, wherein each second apparatus of the at least one second apparatus is an apparatus according to the first aspect of the invention.

Furthermore, according to an exemplary embodiment of the third aspect of the present invention, the system may comprise the network used for transmission between the first apparatus and one of the second apparatuses of the at least one second apparatus.

The features and example embodiments of the invention described above may equally pertain to the different aspects according to the present invention.

It is to be understood that the presentation of the invention in this section is merely by way of examples and non-limiting.

Other features of the invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1a is a block diagram of an exemplary embodiment of an apparatus according to a first aspect of the invention;

FIG. 1b is a flow chart illustrating an exemplary embodiment of a method according to the first aspect the invention;

FIG. 2a is a block diagram of an exemplary embodiment of an apparatus according to a second aspect of the invention;

FIG. 2b is a flow chart illustrating an exemplary embodiment of a method according to the second aspect the invention;

FIG. 3a is an example diagram of an exemplary embodiment of a system according to the first and second aspect of the invention;

FIG. 3b is an example diagram of another exemplary embodiment of a system according to the first and second aspect of the invention;

FIG. 4a shows an example geofence;

FIG. 4b shows an example representation of a geofence according to all aspects of the invention;

FIG. 4c shows an example representation of a geofence according to all aspects of the invention;

FIG. 4d shows an example representation of a geofence according to all aspects of the invention;

FIG. 5a is a flow chart illustrating another exemplary embodiment of a method according to the second aspect of the invention;

FIG. 5b is a flow chart illustrating another exemplary embodiment of a method according to the second aspect of the invention;

FIG. 6 is a flow chart illustrating another exemplary embodiment of a method according to the second aspect of the invention;

FIG. 7a is a flow chart illustrating another exemplary embodiment of a method according to the first aspect of the invention;

FIG. 7b is a flow chart illustrating another exemplary embodiment of a method according to the second aspect of the invention

FIG. 7c is a flow chart illustrating another exemplary embodiment of a method according to the second aspect of the invention;

FIG. 8a is a flow chart illustrating another exemplary embodiment of a method according to the first aspect of the invention;

FIG. 8b is a flow chart illustrating another exemplary embodiment of a method according to the first aspect of the invention;

FIG. 9a shows an example representation of a geofence according to all aspects of the invention;

FIG. 9b shows an example representation of a geofence according to all aspects of the invention;

FIG. 9c is a flow chart illustrating another exemplary embodiment of a method according to the second aspect of the invention;

FIG. 9d is a flow chart illustrating another exemplary embodiment of a method according to the first aspect of the invention;

FIG. 10 is a block diagram of another exemplary embodiment of an apparatus according to the first aspect of the invention; and

FIG. 11 is a block diagram of another exemplary embodiment of an apparatus according to the second aspect of the invention; and

FIG. 12 is a schematic illustration of examples of tangible and non-transitory storage media according to any aspect of the invention.

### DETAILED DESCRIPTION OF THE FIGURES

The following description serves to deepen the understanding of the present invention and shall be understood to complement and be read together with the description of example embodiments of the invention as provided in the above SUMMARY section of this specification.

The following description serves to deepen the understanding of the present invention and shall be understood to complement and be read together with the description of example embodiments of the invention as provided in the above SUMMARY section of this specification.

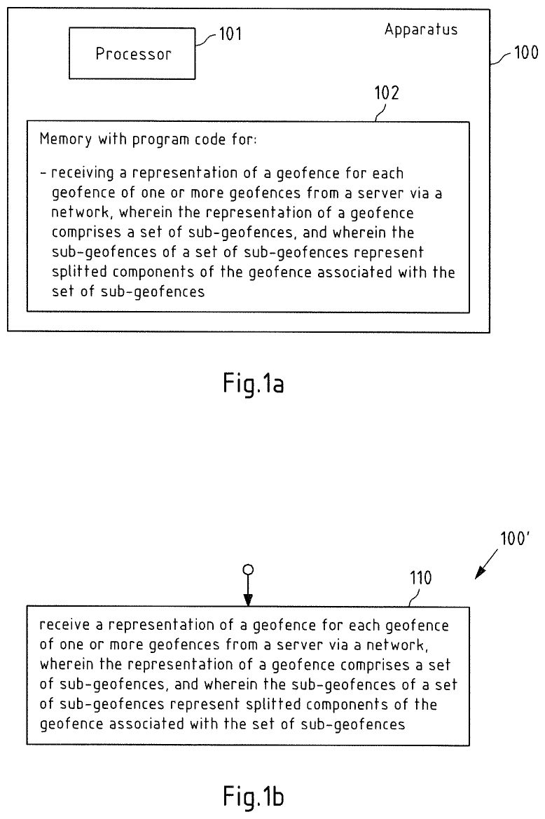

FIG. 1a is a schematic block diagram of an example embodiment of any at least one apparatus according to a first aspect of the invention. Apparatus 100 comprises a processor 101 and, linked to processor 101, a memory 102. Memory 102 stores computer program code for receiving a representation of a geofence for each geofence of one or more geofences from a server via a network, wherein the representation of a geofence comprises a set of sub-geofences, and wherein the sub-geofences of a set of sub-geofences represent splitted components of the geofence associated with the set of sub-geofences.

Apparatus 100 could a client like a mobile or stationary device. If a plurality of apparatus are used, each apparatus may comprise a processor 101, and linked to processor 101, a memory 102, wherein memory 102 at least partially stores computer program code for receiving a representation of a geofence for each geofence of one or more geofences from a server via a network, wherein the representation of a geofence comprises a set of sub-geofences, and wherein the sub-geofences of a set of sub-geofences represent splitted components of the geofence associated with the set of sub-geofences. Apparatus 100 could equally be a component, like a chip, circuitry on a chip or a plug-in board, for any mobile or stationary device. Optionally, apparatus 100 could comprise various other components, like a data interface configured to enable an exchange of data with separate devices, a user interface like a touchscreen, a further memory, a further processor, etc.

An operation of at least one apparatus according to the first aspect of the invention will now be described with reference to the flow chart of FIG. 1b depicting an example embodiment of a method 100′ according to the first aspect of the invention. The operation is an example embodiment of a method according to the first aspect of the invention. At least one processor 101 (may be one processor 101 or a plurality of processors 101) and the program code stored in at least one memory 102 (may be one memory 102 or a plurality of memories 102) cause at least one apparatus (may be one apparatus or a plurality of apparatuses) to perform the operation when the program code is retrieved from memory 102 and executed by processor 101. The at least one apparatus that is caused to perform the operation can be apparatus 100 or some other apparatus.

The at least one apparatus according to the first aspect of the invention receives a representation of a geofence for each geofence of one or more geofences from a server via a network, wherein the representation of a geofence comprises a set of sub-geofences, and wherein the sub-geofences of a set of sub-geofences represent splitted components of the geofence associated with the set of sub-geofences (action 110). As an example embodiment, if a geofence of the one or more geofences is associated with at least one further layer (as exemplarily disclosed with respect to method 900 and in particular action 910 and the explanations thereto), wherein said set of sub-geofences of the representation of the geofence are associated with a first layer and wherein a set of sub-geofences is associated with each layer of the at least one further layer of the geofence, then said receiving a representation of this geofence in action 110 comprises receiving, for each further layer of the least further layer of the geofence, a set of sub-geofences of the respective layer of the geofence.

For instance, said network may represent a wireless network, wherein the wireless network may be any network of a cellular network (e.g. 2G, 3G, 4G, 5G or beyond 5G), a Will network (e.g. based on IEEE 802.11), a Bluetooth network and any other well-suited wireless network. And/or, for instance, said network may comprise or represent the Internet.

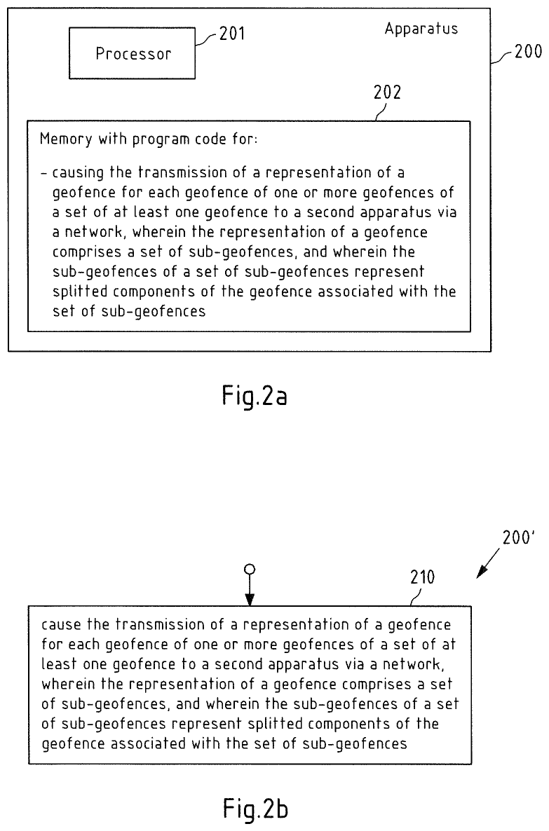

FIG. 2a is a schematic block diagram of an example embodiment of any at least one apparatus according to a second aspect of the invention. Apparatus 200 comprises a processor 201 and, linked to processor 201, a memory 202. Memory 202 stores computer program code for causing the transmission of a representation of a geofence for each geofence of one or more geofences of a set of at least one geofence to a second apparatus via a network, wherein the representation of a geofence comprises a set of sub-geofences, and wherein the sub-geofences of a set of sub-geofences represent splitted components of the geofence associated with the set of sub-geofences.

Apparatus 200 could be a server like a mobile or stationary device, wherein said apparatus 200 may be or may be part of a mobile device or a server of a positioning support system or any other server, e.g. at least one server of a cloud, e.g. an Internet of Things (IoT) cloud. If a plurality of apparatus are used, each apparatus may comprise a processor 201, and linked to processor 201, a memory 202, wherein memory 202 at least partially stores computer program code for causing the transmission of a representation of a geofence for each geofence of one or more geofences of a set of at least one geofence to a second apparatus via a network, wherein the representation of a geofence comprises a set of sub-geofences, and wherein the sub-geofences of a set of sub-geofences represent splitted components of the geofence associated with the set of sub-geofences. For instance, said plurality of apparatuses may represent servers in a cloud interaction together. Apparatus 200 could equally be a component, like a chip, circuitry on a chip or a plug-in board, for any mobile or stationary device. Optionally, apparatus 200 could comprise various other components, like a data interface configured to enable an exchange of data with separate devices, a user interface like a touchscreen, a further memory, a further processor, etc.

An operation of at least one apparatus according to the first aspect of the invention will now be described with reference to the flow chart of FIG. 2b depicting an example embodiment of a method 200′ according to the second aspect of the invention. The operation is an example embodiment of a method according to the second aspect of the invention. At least one processor 201 (maybe one processor 201 or a plurality of processors 201) and the program code stored in at least one memory 202 (may be one memory 202 or a plurality of memories 202) cause at least one apparatus (may be one apparatus or a plurality of apparatuses) to perform the operation when the program code is retrieved from memory 202 and executed by processor 201. The at least one apparatus that is caused to perform the operation can be apparatus 200 or some other apparatus.

The at least one apparatus according to the second aspect of the invention causes a transmission of a representation of a geofence for each geofence of one or more geofences of a set of at least one geofence to a second apparatus via a network, wherein the representation of a geofence comprises a set of sub-geofences, and wherein the sub-geofences of a set of sub-geofences represent splitted components of the geofence associated with the set of sub-geofences (action 210). For instance, the network may be same network as being using in the first aspect of the invention. As an example embodiment, if a geofence of the one or more geofences of the set of at least one geofence is associated with at least one further layer (as exemplarily disclosed with respect to method 900 and action 910 and the explanations thereto), wherein said set of sub-geofences of the representation of the geofence are associated with a first layer and wherein a set of sub-geofences is associated with each layer of the at least one further layer of the geofence, then said causing to transmit a representation of this geofence in action 210 comprises causing to transmit, for each further layer of the least further layer of the geofence, a set of sub-geofences of the respective layer of the geofence.

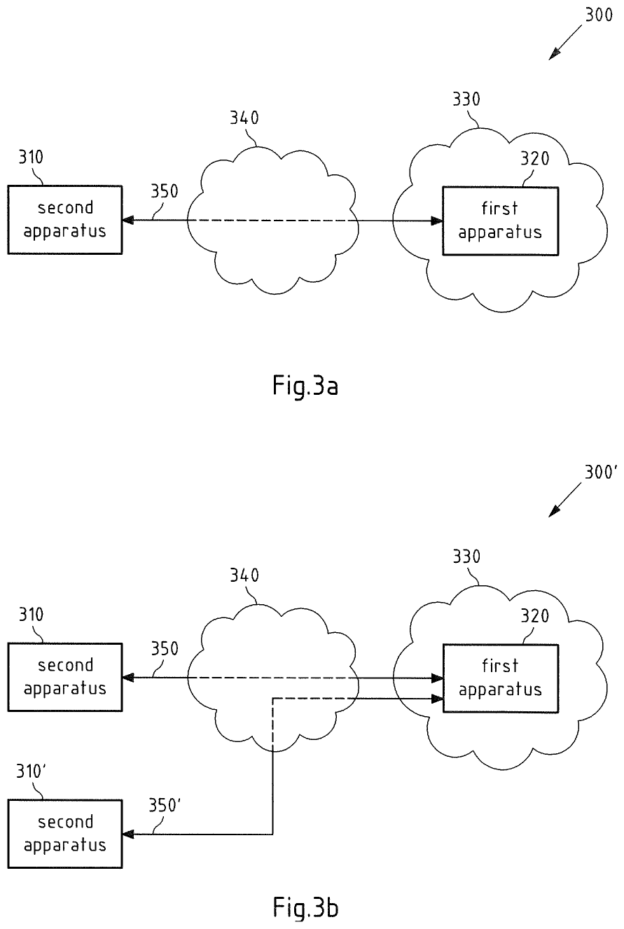

FIG. 3a is a schematic block diagram of an example embodiment of a system 300 comprising a second apparatus 310 according to first aspect of the invention and a first apparatus 320 according to the second aspect of the invention and a network 340. The first apparatus 320 may represent the at least one apparatus according to the second aspect of the invention, as explained above, and might be considered to be located in an optional cloud 330. The second apparatus 310 according to first aspect of the invention may represent at least one apparatus according to the first aspect of the invention, as explained above.

It has to be understood the following explanations may equally hold for the first aspect of the invention and for the second aspect of the invention.

Said second apparatus 310 may be the at least one apparatus according to the first aspect of the invention and said at least one apparatus according to the second aspect of the invention may be server 320 from which the at least one apparatus according the first aspect of the invention receives a representation of a geofence for each geofence of one or more geofences from a server via a network 340 during action 110. It has to be understood that the server 320 may comprise distributed servers 320, e.g. located in an optional cloud 330. Thus, the representation of a geofence for each geofence of one or more geofences of a set of at least one geofence caused to be transmitted in action 210 may be a representation of a geofence for each geofence of one or more geofences received in action 110, wherein the transmission is indicated by arrow 350 in FIG. 3. Accordingly, the at least one apparatus according to the second aspect of the invention (e.g. the first apparatus 320) may cause for each geofence of the one or more geofences a transmission 350 of the representation of the respective geofence. For instance, said network 340 may represent a wireless network, wherein the wireless network may be any network of a cellular network (e.g. 2G, 3G, 4G, 5G or beyond 5G), a Wifi network (e.g. based on IEEE 802.11), a Bluetooth network and any other well-suited wireless network.

For instance, the at least one apparatus according to the second aspect of the invention (e.g. the first apparatus 320) may comprise a database or may be connected to a database, wherein in the database the set of at least one geofence is stored. The set of at least one geofence may represent a plurality of geofences, i.e., a set of geofences. The at least one apparatus according to the second aspect may be configured to determine the one or more geofences from the set of at least one geofence, e.g. by means of selecting the one or more geofences from the set of at least one geofence.

A geofence may be considered to be a virtual perimeter for a real-world geographic area or a virtual perimeter for a real-world geographic line. For instance, a geofence may be set around an area-of-interest or, if the geofence is of type line, the geofence may define a kind of border, e.g. a country border or any other well-suited border. As an example, a geofence may be defined by a point and a geometric shape around the point, e.g. a circle or an ellipse around the point. Or, as another example, a geofence may be defined by a polygon, wherein a polygon may be defined by a predefined set of boundaries. Thus, as an example, the area of a geofence and/or the shape of a geofence may be defined by one of
a polygon;
a rectangle and/or a square;
a cuboid and/or a cube;
an ellipse and/or a circle; and
an ellipsoid and/or a sphere.

Furthermore, as an example, if the geofence is of type line, the line of the geofence may be defined by one of
a polygon, and/or
a straight line (e.g.), and/or
a curve.

A geofence may be considered to define an area-of-interest at and/or around a specific location. For instance, a geofence could be a check point or a check area on the delivery route of a vehicle, e.g. a truck (or any movable mobile device), and somebody could be interested to know and get a notification when the delivery vehicle visits the check point (or check are), which could for example be one of the delivery locations (areas). Of course, a geofence could be used for any other well-suited area-of-interest, e.g. a school attendance zone or any other zone, and, in particular, geofences is not limited to vehicles but may be applied for any movable mobile device.

Thus, as an example embodiment, each geofence of the set of one or more geofences may be associated with at least one action, wherein an action of the at least one action may be triggered if it checked that a location (e.g. the position of a mobile device) is within the geofence, e.g. within an area defined by the geofence, e.g. an area defined by the representation of the geofence.

Or, as another example, if the geofence is of type line, the geofence may be considered to define a border such that it could be checked whether somebody (e.g. an asset, e.g. a vehicle or truck or any movable mobile device) moves over the border being defined by the geofence. For instance, the border may be a country border and thus it can be checked whether an asset has moved over the country border.

FIG. 3b is a schematic block diagram of an example embodiment of a system 300′ comprising at least two second apparatuses 310, 310 according to first aspect of the invention and a first apparatus 320 according to the second aspect of the invention and a network 340. The first apparatus 320 may represent the at least one apparatus according to the second aspect of the invention, as explained above, and might be considered to be located in an optional cloud 330. The second apparatus 310 according to first aspect of the invention may represent at least one apparatus according to the first aspect of the invention and the second apparatus 310′ according to first aspect of the invention may represent at least one apparatus according to the first aspect of the invention, as explained above. System 300′ is based on system 300 and additional comprises the further second apparatus 310′ (it could comprise more than one further second apparatus 310′). The further second apparatus 310′ may correspond to the second apparatus 310 explained with respect to system 300 and with respect to the at least one apparatus according to the second aspect of the invention, therefore, any explanations presented with respect to the at least one apparatus according to the second aspect of the invention may also hold for the further second apparatus 310′. Any explanations given in sequel with respect to the at least one apparatus according to the second aspect (e.g. with respect to apparatus 100 and/or 310) may also hold for the further second apparatus 310′.

Thus, the further second apparatus 310′ receives a representation of a geofence for each geofence of one or more geofences from the first apparatus 320 the network 340 during action 110 by means of transmission 350′. The explanation with respect to transmission 350 also holds for transmission 350′ between the further second apparatus 310′ and the first apparatus 320.

Thus, the first apparatus 320 can transmit the representation of each geofence of one or more geofences of the set of at least one geofence to the second apparatus 310 and at least one further second apparatus 310′. Accordingly, the first apparatus 320 may provide multiple clients the representation of each geofence of one or more geofences of the set of at least one geofence.

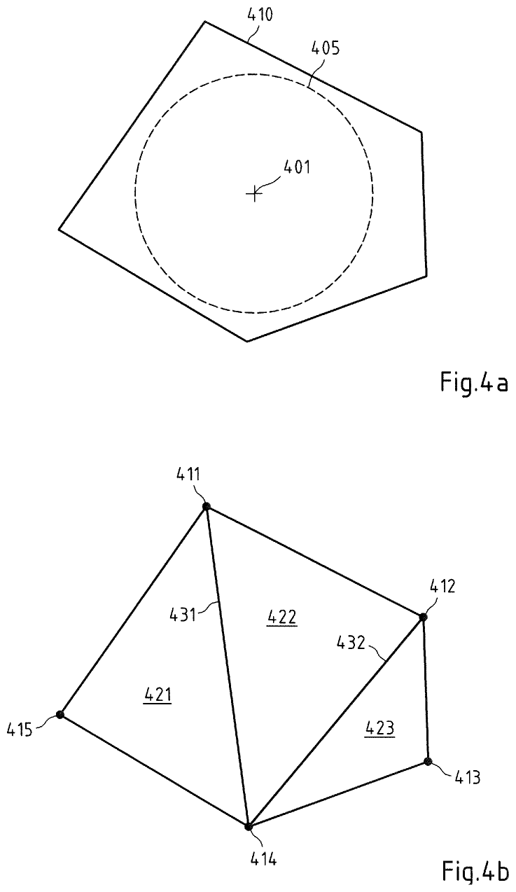

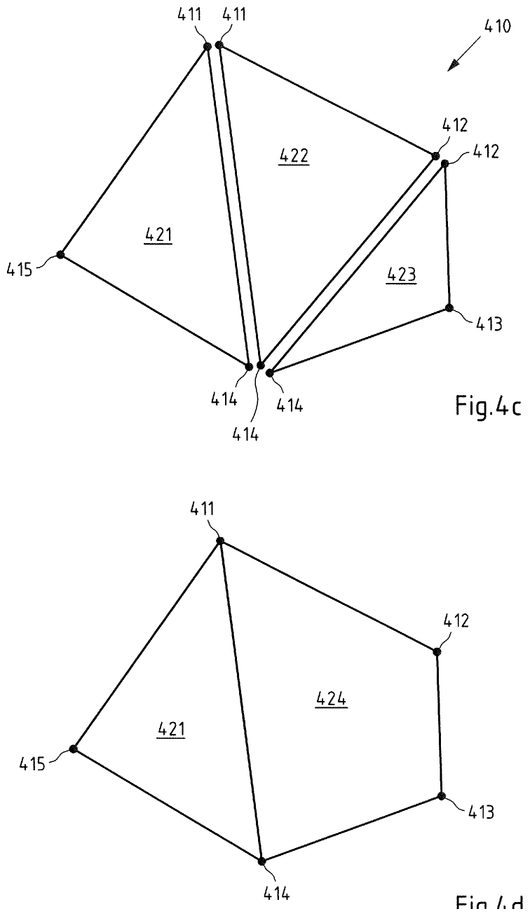

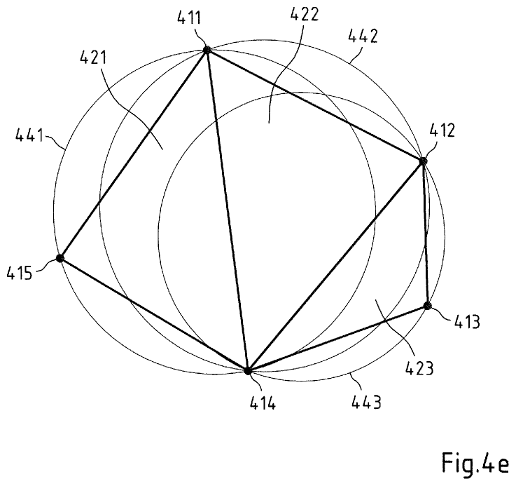

FIG. 4a shows a non-limiting example of a geofence 410 which is defined by a polygon 410. For instance, said geofence 410 may be set around an optional area-of-interest 405 and around an optional point 401. For instance, said polygon 410 may be a standard polygon which enables the capture of a complex area in the real-word. In FIG. 4a, as an example, point 401 may define the centre of the area defined by geofence 401. The polygon of geofence 410 is of order 5 since it comprises five points 411, 412, 413, 414, 415.

FIG. 4b shows a non-limiting of a representation of geofence 410 comprising a set of sub-geofences 421, 422, 423 representing splitted components of the geofence 410. In this example, the geofence 410 is splitted along lines 432 and 431 in order to obtain the set of sub-geofences comprising a first sub-geofence 421, a second sub-geofence 422 and a third sub-geofence 423.

According to an example embodiment, the geofence associated with a set of sub-geofences may be defined at least partially based on a polygon of order m, and wherein a sub-geofence of the set of sub-geofences associated with the geofence is defined by a polygon of order n, with n<m.

For instance, in this example depicted in FIGS. 4a and 4b a sub-geofences 421, 422, 423 of the set of sub-geofences 421, 422, 423 may be considered to have less geometrical complexity compared to the geometrical complexity of the geofence 410 associated with this set of sub-geofences 421, 422, 423, since in this example the geofence 410 associated with the set of sub-geofences 421, 422, 423 is defined at least partially based on a polygon of order m (e.g., with m=5 in this example), wherein a sub-geofence 421, 422, 423 of the set of sub-geofences 421, 422, 423 associated with the geofence 410 is defined by a polygon of order n, with n<m. In this example, each sub-geofence 421, 422, 423 of the set of sub-geofences 421, 422, 423 is defined by a triangle, i.e., a polygon of order n=3, wherein n=3<m=5 holds.

According to an example embodiment, each sub-geofence of a set of geofences may be defined by a triangle.

Thus, the geofence 410 can be expressed by the set of sub-geofences 421, 422, 423 which defines a representation of geofence 410, wherein each geofences 421, 422, 423 of the set of sub-geofences 421, 422, 423 has a less geometrical complexity compared to the geometrical complexity of the geofence 410. For instance, this set of sub-geofences 421, 422, 423 may be used for geofencing purposed. This may show the advantage that it can be easier to detect whether the coordinates of a given point are located inside or outside of any of the simple (or simplified) sub-geofences of the set of sub-geofences instead of detecting whether the coordinates of a given point are located inside or outside the polygon 410 of geofence 410, since it is easier to detect if a point is located within a triangle or not compared to detecting if a point is located in a polygon of order 5. Therefore, it may enable to reduce power consumption at an apparatus checking whether a given point (e.g. a position) is within the geofence 410 when using the representation of the geofence 410 comprising a set of sub-geofences 421, 422, 423.

According to an example embodiment, the sub-geofences of a set of sub-geofences do not overlap with each other, as exemplarily shown in FIGS. 4b and 4d. For instance, a set of sub-geofences of a representation of a geofence 410 may be an exact representation of the geofence 410, i.e., an area being defined by set of sub-geofences (e.g. sub-geofences 421, 422, 423 or sub-geofences 421, 424) of a representation of a geofence 410 may match to the area defined by the geofence (e.g. geofence 410).

It has to be understood that the present invention is not limited to geofence being represented by a polygon, and it is not limited to split a polygon into triangles, but to represent a geofence by a set of sub-geofences, wherein the sub-geofences represent splitted components of the geofence.

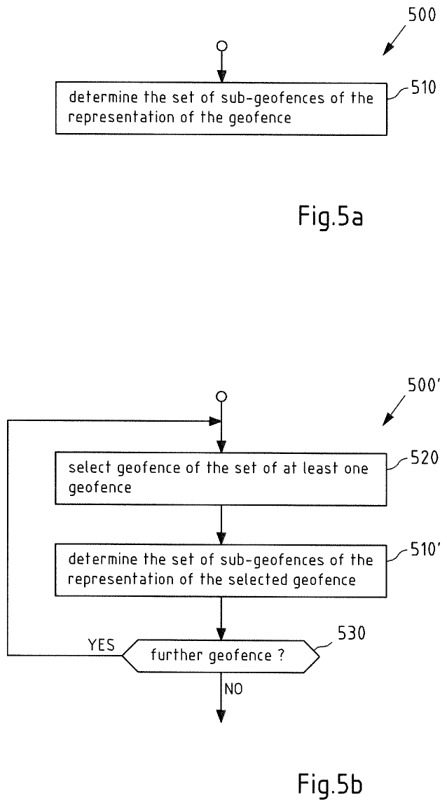

FIG. 5a depicts an example embodiment of a method 500 according to the second aspect of the invention. Thus, method 500 may be performed by the at least one apparatus according to second aspect of the invention, e.g. by apparatus 200 or by apparatus 320.

Method 500 comprises determining a set of sub-geofences of a representation of a geofence of the set of at least one geofence (action 510). For instance, said determining a set of sub-geofences of the representation of a geofence comprises splitting the respective geofence into a set of sub-geofences.

Thus, with respect to the example of a geofence 410 depicted in FIG. 4a a set of sub-geofences of a representation of the geofence 410 may by determined by splitting the geofence 410 into at least two sub-geofences, wherein the at least two-sub-geofences define the set of sub-geofences as representation of the geofence 410.

For instance, as exemplarily shown in FIGS. 4b and 4c, the polygon 410 of geofence 410 may be splitted into three sub-geofences 421, 422, 423, wherein each of the three sub-geofences 421, 422, 423 is defined by a polygon having an order being lower than the order of polygon 410 of geofence 410, wherein a first sub-geofence 421 may represent a triangle being defined by points 411, 414, 415, a second sub-geofence 422 may represent a triangle being defined by points 411, 412, 414, and a third sub-geofence 423 may represent a triangle being defined by points 412, 413, 414. As has already been explained, a sub-geofences 421, 422, 423 of the set of sub-geofences 421, 422, 423 has less geometrical complexity compared to the geometrical complexity of the geofence 410. Thus, as an example, said splitting the geofence 410 into at least two sub-geofences may comprise splitting the geofence 410 into at least two sub-geofences 421, 422, 423, wherein each of the at least two sub-geofences 421, 422, 423 is represented by a triangle 421, 422, 423. E.g., said splitting the geofence 410 into at least two sub-geofences may comprise splitting the geofence 410 into triangles 421, 422, 423, wherein the triangles 421, 422, 423 represent the set of sub-geofences 421, 422, 423

Or, for instance, as exemplarily shown in FIGS. 4d, the polygon 410 of geofence 410 may be splitted into two sub-geofences 421, 424, wherein each of the two sub-geofences 421, 424, 423 is defined by a polygon having an order being lower than the order of polygon 410. The first sub-geofence 421 may represent a triangle being defined by points 411, 414, 415 and thus representing a polygon of order n=3, and the second sub-geofence 424 may represent a polygon of order n=4 comprising four points 411, 412, 413 and 414. Thus, a sub-geofences 421, 424 of the set of sub-geofences 421, 424 has less geometrical complexity compared to the geometrical complexity of the geofence 410.

According to an example embodiment, said determining a set of sub-geofences 421, 422, 423 of a representation of a geofence 410 of the set of at least one geofence in action 510 may comprise determining the set sub-geofences 421, 422, 423 such that each sub-geofence of the set of sub-geofences 421, 422, 423 has less geometrical complexity compared to the geometrical complexity of the geofence 410. For instance, if the sub-geofences are represented by polygon and the geofence is represented by a polygon, the geometrical complexity of a sub-geofence may be represented by the order of the polygon of the sub-geofence and the geometrical complexity of the geofence 410 may be represented by the order of the polygon 410 of the geofence 410.

And/or, according to an example embodiment, said determining a set of sub-geofences 421, 422, 423 of a representation of a geofence 410 of the set of at least one geofence in action 510 may be performed based on a Delaunay triangulation, e.g. as exemplarily described in https://en.wikipedia.org/wiki/Delaunay triangulation in the version of May 3, 2018 accessible via “view history”. The Delaunay triangulation may be considered to b e a triangulation for a given set P of discrete points in a plane such that no point in P is inside the circumcircle of any triangle in the triangulation. For instance, with respect to the example of geofence 410 in FIG. 4b, the given set P of discrete points may comprise the points 411, 412, 413, 414 and 415 (being assumed to be in a plane), wherein the triangles 421, 422 and 423 of the Delaunay triangulation are determined such that no point P is inside the circumcircle 441, 442, 443 of any triangle 421, 422 and 424 of the Delaunay triangulation, as exemplarily depicted in FIG. 4e. It has to be understand the said determining a set of sub-geofences 421, 422, 423 of a representation of a geofence 410 of the set of at least one geofence in action 510 is not limited to a Delaunay triangulation, but any other well-suited algorithm can be used for determining a set of sub-geofences 421, 422, 423 of a representation of a geofence 410 of the set of at least one geofence in action 510.

According to an example embodiment, each sub-geofence of a set of sub-geofences of a representation of a geofence of the set of at least one geofence may be represented by a triangle, wherein each triangle of the set of sub-geofences fulfills the Delaunay triangulation criteria, i.e., no point in P of the polygon of the geofence is inside the circumcircle of any triangle of the sub-geofences of the represenation of this geofence.

FIG. Sb depicts an example embodiment of a method 500′ according to the second aspect of the invention. Thus, method 500′ may be performed by the at least one apparatus according to the second aspect of the invention, e.g. by apparatus 200 or by apparatus 320.

In action 520 a geofence of the set of at least one geofence is selected.

Then, in action 510′ a set of sub-geofences of a representation of the selected geofence is determined. This determining a set of sub-geofences of a representation of the selected geofence in action 510′ may be performed as explained with respect to action 510 of method 500, i.e., action 510′ may correspond to action 510.

Then it may be checked whether there is a further geofence in the set of at least one geofence for which a set of sub-geofences shall be determined (action 530) if the set of at least one geofence represent a plurality of geofences. If yes, method 500 may proceed with selecting this further geofence of the set of at least one geofence in action 520 and may determining a set of sub-geofences of a representation of the selected geofence in action 510.

For instance, the loop depicted in FIG. 5b may be processed for each geofence of the set of at least one geofence. Then, for instance, apparatus 100 or apparatus 200 may comprise for each geofence of the set of at least one geofence a representation of the respective geofence, wherein the representation of the respective geofence comprises a set of sub-geofences, and wherein the sub-geofences of the set of sub-geofences represent splitted components of the respective.

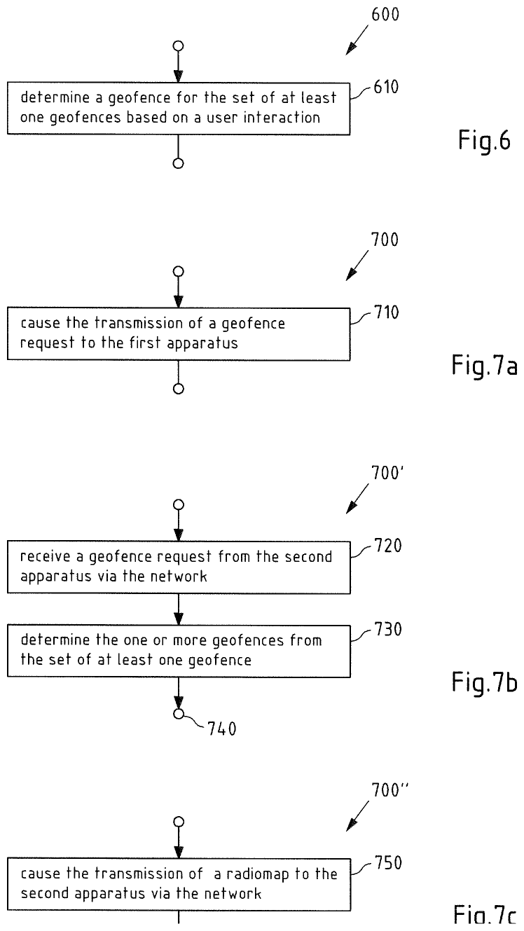

FIG. 6 depicts an example embodiment of a method 600 according to the second aspect of the invention. Thus, method 600 may be performed by the at least one apparatus according to second aspect of the invention, e.g. by apparatus 200 or by apparatus 320.

In action 610 a geofence of the set of at least one geofences is determined based on a user interaction. For instance, said user interaction with apparatus 200 or apparatus 320 may be performed via a user interface of the apparatus 200 or apparatus 320, or via a network that that the user may connect with a user's device with apparatus 200 or apparatus 320. Based on the user interaction, the user may define a geofence, e.g. a geographical area of arbitrary shape and, for instance, the user may define at least one action being associated with the geofence. Thus, for instance, action 610 may further comprise associated the at least one action with the determined geofence, e.g. based on the user interaction.

As a non-limiting example, area 405 depicted in FIG. 4a may be an area defined by a user by means of the user interaction.

Based on the user interaction a geofence 410 is determined, wherein this geofence 410 may be around the area 405. For instance, this geofence 410 may have any well-suited shape. As an example, the determined geofence 410 may be represented by a polygon 410.

For instance, action 610 may be performed for a plurality of geofences, wherein each geofence of the plurality of geofences is determined based on a user interaction. It has to be noted that this user interaction must not necessarily stem from the same user but may stem from different users. Thus, one or more users may define the plurality of geofence which may considered to represent the set of at least one geofence.

FIG. 7a depicts an example embodiment of a method 700 according to the first aspect of the invention. Thus, method 700 may be performed by the at least one apparatus according to the first aspect of the invention, e.g. by apparatus 100 or by apparatus 310.

Method 700 comprises causing the transmission of a geofence request to the first apparatus via the network 340 (action 710), wherein the first apparatus is the at least one apparatus according to the second aspect of the invention (e.g. apparatus 200 or apparatus 310, which may be a server). For instance, action 710 may be performed before action 110 is performed. In the sequel, the first apparatus is the at least one apparatus according to the second aspect of the invention (e.g. apparatus 200 or apparatus 310, which may be a server).

As an example, the geofence request may comprise at least one parameter, wherein the at least one parameter may comprises a location information and/or an information regarding storage size. For instance, the location information may comprise an actual location (e.g. position) estimate of apparatus 100 or apparatus 310 and/or may comprise an anticipated future location (e.g. position) estimate of the apparatus 100 or apparatus 310. And/or, for instance, the information regarding storage size may be indicative of available storage space of apparatus 100 and apparatus 310 that could be used for storing the received representation of a geofence for each geofence of the one or more geofences received during action 110, and, as an example, further data received from the at least one apparatus according to the second aspect of the invention (e.g. apparatus 200 or apparatus 310, which may be a server).

FIG. 7b depicts an example embodiment of a method 700′ according to the second aspect of the invention. Thus, method 700′ may be performed by the at least one apparatus according to the second aspect of the invention, e.g. by apparatus 200 or by apparatus 320.

Method 700′ comprises receiving a geofence request from the second apparatus 100, 310 via the network 340 in action 710, wherein the second apparatus is the at least one apparatus according to the first aspect of the invention and may be represented by apparatus 100 or apparatus 310. The geofence request received in action 710 may be the geofence request caused to be transmitted by action 710 of method 700. In the sequel, the second apparatus is the at least one apparatus according to the first aspect of the invention and may be represented by apparatus 100 or apparatus 310.

Then, in method 700′ the one or more geofences are determined from the set of at least one geofence (action 730), wherein the one or more geofences are said one or more geofences for each them a representation of a geofence of the one or more geofences is caused to be transmitted in action 210 of method 200′ and received in action 110 of method 100′. For instance, said determining the one or more geofences from the set of at least one geofence (action 730) may be performed be selecting the one or more geofences from the set of at least one geofence.

As an example, said determining the one or more geofences from the set of at least one geofence (action 730) may be performed based on a location estimate of the second apparatus 100, 310. For instance, the first apparatus 200, 320 may know and/or may track to location of the second apparatus 310, e.g. based on location updates provided from the second apparatus 100, 310 to the first apparatus 200, 320 (which can be separate from the geofence request). As an example, the location estimate may be an estimation of an actual location (e.g. position) estimate of the second apparatus 100, 310 and/or may be an anticipated future location (e.g. position) estimate of the second apparatus 100, 310. And/or, the geofence request received in action 720 may comprise the above mentioned location information which can be used to determine the location estimation.

Thus, the one or more geofences may be determined to be within a predefined range with respect to the location estimate of the second apparatus 100, 310. For instance, the one or more geofence may represent a sub-set of geofences of the set of at least one geofence.

And/or, for instance, the determining the one or more geofences from the set of at least one geofence (action 730) may be performed based on information regarding storage size associated with the second apparatus 100, 310. As an example, the geofence request received in action 720 may comprise the information regarding storage size associated with the second apparatus 100, 310. Thus, it may be ensured that all representations of geofences of the determined one or more geofences can be stored in apparatus 100, 310.

And/or, as an example, said determining the one or more geofences from the set of at least one geofence (action 730) may be performed based on a radio map associated with the second apparatus 100, 320, e.g. the radio map caused to be transmitted in action 750. For instance, the radio map may be used by the second apparatus 100, 320 for performing positioning estimation, e.g. offline positioning. E.g., the one or more geofences are geofences within an area defined by the radio map. Thus, it may be avoided that representations of geofences are transmitted to the second apparatus 100, 310 which can be not be used to due limited coverage of the radio map applied by the second apparatus 100, 310 and therefore, for instance, geofence downloading may be limited to the area where the second apparatus 100, 310 have radiomaps.

Then, after the one or more geofences are determined in action 730, method 700″ may proceed at reference sign 740 with method 200 in order to causes the transmission of a representation of a geofence for each geofence of the one or more geofences (the one or more geofences determined in action 730) of the set of at least one geofence to the second apparatus 100, 310 via the network 340, wherein the representation of a geofence comprises a set of sub-geofences, and wherein the sub-geofences of a set of sub-geofences represent splitted components of the geofence associated with the set of sub-geofences (action 210).

FIG. 7b depicts an example embodiment of a method 700″ according to the second aspect of the invention. Thus, method 700″ may be performed by the at least one apparatus according to the second aspect of the invention, e.g. by apparatus 200 or by apparatus 320. Method 700′ comprises causing the transmission of a radiomap to the second apparatus 100, 310 via the network 340 (action 750).

The radio map may be assumed to represent a model of a radio network (e.g. Wifi (WLAN) or Bluetooth or any other radio communications system, e.g. a cellular radio communication system like 2G, 3G, 4G, 5G, which can be used for positioning purposes.

For instance, method 100 performed by the second apparatus 100, 310 may comprise receiving this radiomap from the first apparatus 200, 320 via the network 340.

As an example, this radio map may be used by the second apparatus 200, 320 for performing positioning, e.g. for estimating the location of the second apparatus 200, 320. For instance, this radio map may enable to perform offline positioning at the second apparatus 200, 320, e.g. without the requirement of an active network connection from the second apparatus 200, 320 to a server for requesting and receiving specific positioning information. As an example, it is sufficient to measure the signal strength of signals from different access points of the radio network at the second apparatus 100 and 320 such that the position of the second apparatus 100 and 320 can be determined based on the signal strength measurements of the different access points (and e.g. the received identifiers of the different access points) and using the radio map associated with this radio network. For instance, the radio network may be part of the network 340 and/or may represent a separate network compared to the network 340.

As an example, said causing the transmission of a radiomap to the second apparatus 100, 310 via the network 340 (action 750) may be performed in response to receiving the geofence request in action 720. Thus, for instance, no additional request for requesting a radiomap is necessary.

As an example, said radio map caused to be transmitted to the second apparatus 100, 310 via the network 340 may be determined from a second radio map, in particular based on the (optional) geofence request.

For instance, said radio map caused to be transmitted may be determined from the second radio map based on a location estimate of the second apparatus 100, 310. For instance, the first apparatus 200, 320 may know and/or may track to location of the second apparatus 310, e.g. based on location updates provided from the second apparatus 100, 310 to the first apparatus 200, 320 (which can be separate from the geofence request). As an example, the location estimate may be an estimation of an actual location (e.g. position) estimate of the second apparatus 100, 310 and/or may be an anticipated future location (e.g. position) estimate of the second apparatus 100, 310. And/or, the geofence request received in action 720 may comprise the above mentioned location information which can be used to determine the location estimation. Thus, the radio map caused to be transmitted in action 750 may represent a sub-set of the second radio map, wherein the sub-set covers an area depending on the estimated location of the second apparatus 310, and wherein this area is a part of a full area covered by the second radio map.

As an example, said radio map transmitted during action 750 may represent a compressed version of a radio map. For instance, this compressed version of a radio map may be derived from the second radio map, which may be stored in a database of the at least one apparatus according to the second aspect of the invention or connected to the at least one apparatus according to the second aspect of. E.g., the compressed version of a radio map comprise less data compared to the second radio map with respect to the coverage area defined by the compressed radio map. For instance, the compressed version of a radio map may represent a compressed version of the above mentioned sub-set of the second radio map associated with an area depending on the estimated location of the second apparatus 310, wherein this area is a part of a full area covered by the second radio map.

And/or, as an example, said radio map caused to be transmitted may be determined based on information regarding storage size associated with the second apparatus 100, 310. As an example, the geofence request received in action 720 may comprise the information regarding storage size associated with the second apparatus 100, 310. Thus, it may be ensured that the radio map caused to be transmitted in action 750 can be stored in apparatus 100, 310. For instance, the rate of compression of the compressed version of a radio map may be determined based on the information regarding storage size associated with the second apparatus 100, 310.

And/or, as an example, said determining the one or more geofences in action 730 of method 700′ and determining the radio map caused to be transmitted in action 750 of method 500′ may be determined in conjunction based on the information regarding storage size associated with the second apparatus 100, 310 such that it may be ensured to the all representations of geofences of the determined one or more geofences (caused to be transmitted in action 210) can be stored in apparatus 100, 310 and the radio map caused to be transmitted in action 750 can be stored in apparatus 100, 310.

For instance, said radio map may caused to be transmitted to the second apparatus 100, 310 via the network 340 may be determined from a second radio map based on the geofence request.

As an example embodiment, said causing the transmission of a radiomap to the second apparatus 100, 310 via the network 340 in action 750 may be performed as part of method 200′, wherein, in particular, said transmission of a representation of a geofence for each geofence of one or more geofences of the set of at least one geofence to the second apparatus 100, 310 via a network 340 caused by action 210 and said transmission of a radiomap to the second apparatus 100, 3100 via the network 340 caused by action 750 is performed during a same transmission session. Thus, as an example, said receiving a radiomap from a server (i.e. the at least one apparatus according to the second aspect of the invention) 200, 320 via the network 340 in action 150 at the first apparatus 100, 310 may be performed in such a way that receiving a representation of a geofence for each geofence of one or more geofences from a server (i.e. the at least one apparatus according to the second aspect of the invention) 200, 320 via a network 340 in action 110 said receiving a radiomap from the server (i.e. the at least one apparatus according to the second aspect of the invention) 200, 320 via the network 340 is performed during a same transmission session.

For instance, said same transmission session may comprise combining first data defining the representation of a geofence for each geofence of one or more geofences of the set of at least one geofence caused to be transmitted to the second apparatus 100, 310 via a network 340 by action 210 and second data defining the a radiomap caused to be transmitted to the second apparatus 100, 310 via the network 340 by action 750, such that the first and second data is at least partially combined when transmitted from the first apparatus 200, 320 to the second apparatus 100, 310 via the network 340, e.g. by means of combining packets of the first data and the second data during said transmission. Thus, the first data and the second data may be transferred in one transmission session, e.g. based on the geofence request received in action 720, such that there is not additional data request (e.g. for the radio map) is necessary.

Thus, for instance, the representation of a geofence for each geofence of one or more geofences of the set of at least one geofence caused to be transmitted to the second apparatus 100, 310 via a network 340 by action 210 may be distributed to the second apparatus 100, 320 by combined data transmission together with the off-line positioning defined by the radiomap caused to be transmitted to the second apparatus 100, 310 via the network 340 by action 750.

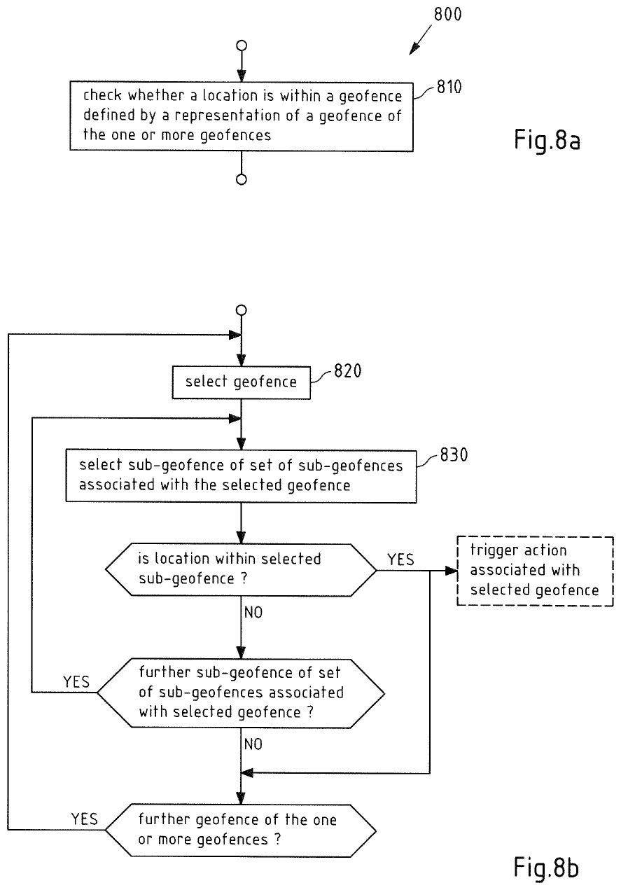

FIG. 8a depicts an example embodiment of a method 800 according to the first aspect of the invention. Thus, method 800 may be performed by the at least one apparatus according to the first aspect of the invention, e.g. by apparatus 100 or by apparatus 310.

In method 800 it is checked whether a location is within a geofence defined by a representation of a geofence of the one or more geofences (action 810).

For instance, the location may be the location of apparatus 100 or apparatus 310 according to the first aspect of the invention. As an example, the location may be estimated by apparatus 100 or apparatus 310, e.g. by means of a positioning detector of the apparatus 100, 310, wherein, as a further example, said location may be estimated based on a radio map stored in apparatus 100, 310. For instance, said radio map may represent a radio map received from the first apparatus 200, 320 via the network 340 by means of the transmission caused by action 750 of method 700″. E.g., said estimating the location may be performed by an offline-line positioning, e.g. as explained above. Thus, as an example, method 800 may comprise determining the location based on a radio map, in particular said radio map received from the first apparatus 200, 320 via the network 340.

Based on the location it can be checked whether the location is within a geofence defined by a representation of a geofence of the one or more geofences (action 810), wherein this checking may comprise determining whether the location is within an area defined by a representation of a geofence of the one or more geofences (action 810).

If said checking performed in action 810 is successful, i.e. if it determined that the location is within a geofence defined by a representation of a geofence of the one or more geofences, at least one action associated with the respective geofence may be trigged. For instance, such at least one action associated with a geofence may comprise providing a notification to a user, e.g. sending a message from the apparatus 100, 310 to another apparatus, e.g. via network 340 or via another network, or, providing the notification via a user interface (e.g. a display and/or a speaker or etc.) of apparatus 100, 310 to a user. Thus, action 810 may be considered to perform geofencing at least partially based on the representation of a geofence of the one or more geofences received in action 110 of method 100′.

As an example, said checking whether a location of the apparatus is within a geofence defined by a representation of a geofence of the one or more geofences may be performed based on barycentric coordinates. E.g., the location may be expressed by coordinates in the barycentric coordinate system e.g. as exemplarily described in https://en.wikipedia.org/wiki/Barycentric_coordinate_system in the version of Dec. 21, 2017 accessible via “view history”, and it may be checked whether these coordinates of the location are within a geofence defined by a representation of a geofence of the one or more geofences, e.g. as exemplarily described in https://en.wikipedia.org/wiki/Barycentric_coordinate_system#Determining_location_with_respect_to_a_triangle in the version of Dec. 21, 2017 accessible via “view history”.

For instance, said check performed in action 810 can be performed for each geofence of the one or more geofences, and it may be checked for each geofence of the one or more geofences whether the location is within a geofence defined by a representation of the respective geofence or not.

As an example, said checking whether a location (e.g. of the apparatus) is within a geofence defined by a representation of a geofence of the one or more geofences (action 810) comprises for each geofence of at least one geofence of the one or more geofences checking if the location is within in a sub-geofence of the set of sub-geofences associated with the respective geofence. The representation of a geofence of the one or more geofences comprises a set of sub-geofences and therefore, as an example, it can be checked whether the location is within one sub-geofence of the set of sub-geofences of the respective geofence or not. Thus, the checking for a respective geofence may yield in a positive result if the location is within one sub-geofence of the set of sub-geofences of the respective geofence. Furthermore, e.g., said checking for a respective geofence may yield in a negative result for a respective geofence if the location is not within each sub-geofence of the set of sub-geofences of the respective geofence.

As an example, said checking if the location is within in a sub-geofence of the set of sub-geofences associated with the geofence may be performed based on barycentric coordinates. E.g., the location may be expressed by coordinates in the barycentric coordinate system and it may be checked whether this coordinates of the location are within a sub-geofence of the set of sub-geofences associated with the geofence.

For instance, with respect to the example of a geofence 410 depicted in FIG. 4a, the set of sub-geofences of this geofence might be sub-geofences 411, 421, 431 as exemplarily depicted in FIG. 4b, and thus, in action 810 it may be checked if the location is within one of the sub-geofences 411, 421, 431 of the set of sub-geofences 411, 421, 431.

Since the geofence 410 is be expressed by the set of sub-geofences 421, 422, 423 which defines a representation of geofence 410, wherein each geofences 421, 422, 423 of the set of sub-geofences 421, 422, 423 has a less geometrical complexity compared to the geometrical complexity of the geofence 410, this may show the advantage that it can be easier to detect whether the coordinates of a given point (i.e. the location used in action 810 or in action 840) are located inside or outside of any of the simple (or simplified) sub-geofences of the set of sub-geofences instead of detecting whether the coordinates of a given point are located inside or outside the polygon 410 of geofence 410, since it is easier to detect if a point is located within a triangle or not compared to detecting if a point is located in a polygon of order 5. Therefore, it may enable to reduce power consumption at an apparatus checking whether a given point (e.g. a position) is within the geofence 410 when using the representation of the geofence 410 comprising a set of sub-geofences 421, 422, 423.

Furthermore, for instance, said checking whether a location is within in a sub-geofence of the set of sub-geofences associated with the geofence may be performed based on barycentric coordinates, and this may result to a very efficient checking, in particular in case that sub-geofence is represented by a triangle.

FIG. 8b depicts an example embodiment of a method 800′ according to the first aspect of the invention. Thus, method 800′ may be performed by the at least one apparatus according to the first aspect of the invention, e.g. by apparatus 100 or by apparatus 310. For instance, method 800′ may represent an example of an implementation of method 800 depicted in FIG. 8a.

In action 820 a geofence of the one or more geofences is selected.

Then, in action 830 a sub-geofence of the set of sub-geofences associated with the selected geofence is selected.

In action 840 it is checked whether the location (e.g. the location of apparatus 100, 310) is within the selected sub-geofence. Thus, it may be checked whether coordinates of the location are within an area defined by the selected sub-geofence. For instance, the location may be estimated by apparatus 100 or apparatus 310, e.g. by means of a positioning detector of the apparatus 100, 310, as explained with respect to method 800.

As an example, said checking if the location is within in the selected sub-geofence in action 840 may be performed based on barycentric coordinates. E.g., the location may be expressed by coordinates in the barycentric coordinate system and it may be checked whether this coordinates of the location are within the selected sub-geofence.

If said checking in action 840 yields a positive result, this may indicate that the location is within an area defined by the representation of the selected geofence, and the method 800′ may proceed with optional action 850 in order to trigger at least one action associated with the selected geofence, e.g. as explained above.

Furthermore, if said checking in action 840 yields a positive result, and if there are further sub-geofences of the set of sub-geofences of the selected geofence which have not been checked in a preceding action 840, it is not necessary to check whether the location is within one of these further sub-geofences, since it has already been detected that the location is within the selected geofence. Thus, if said checking in action 840 yields a positive result, method 800′ may proceed with action 870 in order to check whether there is a further geofence of the one or more geofences for which geofencing shall be performed. If yes, the method 800′ may jump to action 820 in order to selected this further geofence and the method can proceed with checking whether a location is within in a sub-geofence of the set of sub-geofences of the selected geofence.

If said checking in action 840 yields a negative result, i.e., the location is not within the selected sub-geofence, it is checked in action 860 whether there is a further sub-geofence of the set of sub-geofences associated with the selected geofence, wherein this further sub-geofence of the set of sub-geofences associated with the selected geofence may represent a sub-geofence for which no checking in action 840 has been perform during the preceding loop(s) of steps 830 and 840. Thus, action 860 ensures that each sub-geofence of the set of sub-geofences associated with the selected geofence is selected in action 830 until all sub-geofences of the set of sub-geofences associated with the selected geofence has been selected in action 830 and checked in action 840 or until the checking in action 840 yields in a positive result.

As an example, actions 830, 840 and 860 may be considered to be an example implementation of checking whether a location is within in a sub-geofence of the set of sub-geofences of the selected geofence.

According to an example embodiment of each aspect of the invention, said set of sub-geofences of a representation of a geofence for each geofence of the one or more geofences of the set of at least one geofence is associated with a first layer, and wherein for each geofence of at least one geofence of the one or more geofences the representation of the geofence is associated with at least one further layer, wherein each layer of the at least one further layer associated with the representation of the geofence comprises a set of sub-geofences being at least partially nested with the set of sub-geofences of the first layer associated with the geofence; wherein, in particular, each layer of the at least one further layer associated with the representation of the geofence is part of the representation of a geofence.

Thus, for instance, a set of sub-geofences of a representation of a geofences determined in action 610 of method 600 may be considered to be associated with the first layer. As an example, each set of sub-geofences of a representation of each geofence of the set of at least one geofence mentioned before may be considered to be associated with the first layer. E.g., the set of sub-geofences 421,422, 423 of geofence 410 depicted in FIG. 4b and/or the set of sub-geofences 421,424 of geofence 410 depicted in FIG. 4d may be considered to be associated with the first layer.

Furthermore, in addition to this first layer at least one further layer may be defined. Then, for instance, for each geofence of at least one geofence of the set of at least one geofence the respective geofence may be associated with at least one further layer, wherein each layer of the at least one further layer associated with the respective representation of the geofence comprises a set of sub-geofences being at least partially nested with the set of sub-geofences of the first layer associated with the geofence. E.g., the set of sub-geofences of the first layer associated with the geofence may represent a first representation of the geofence 410, and the set of sub-geofences of a further layer of associated with said geofence may be considered to represent a further representation of the geofence 410, wherein such a further representation of the geofence may not be exactly the same as the first representation of the geofence.

As an example, if a geofence of the set of at least one geofence is associated with at least one further layer, wherein each wherein each layer of the at least one further layer associated with the representation of the geofence comprises a set of sub-geofences being at least partially nested with the set of sub-geofences of the first layer associated with the geofence, then said representation of the geofence, if caused to be transmitted in action 210 of method 200′ and/or received in action 110 of method 100′, comprises, in addition to the set of sub-geofences of the first layer of this geofence, a set of sub-geofences for each layer of the at least one further layer being associated with the respective geofence.

Accordingly, each layer of the at least one further layer (each layer comprising the respective set of sub-geofences associated with this layer) associated with the geofence may be considered to be a part of the representation of this geofence.

Thus, by means of actions 110 and 210 for each geofence of the one or more geofences for which at least one further layer is associated, in addition to the set of sub-geofences of the first layer of this geofence, a set of sub-geofences for each layer of the at least one further layer being associated with the respective geofence can be caused to be transmitted by action 210 and/or can be received by action 110.

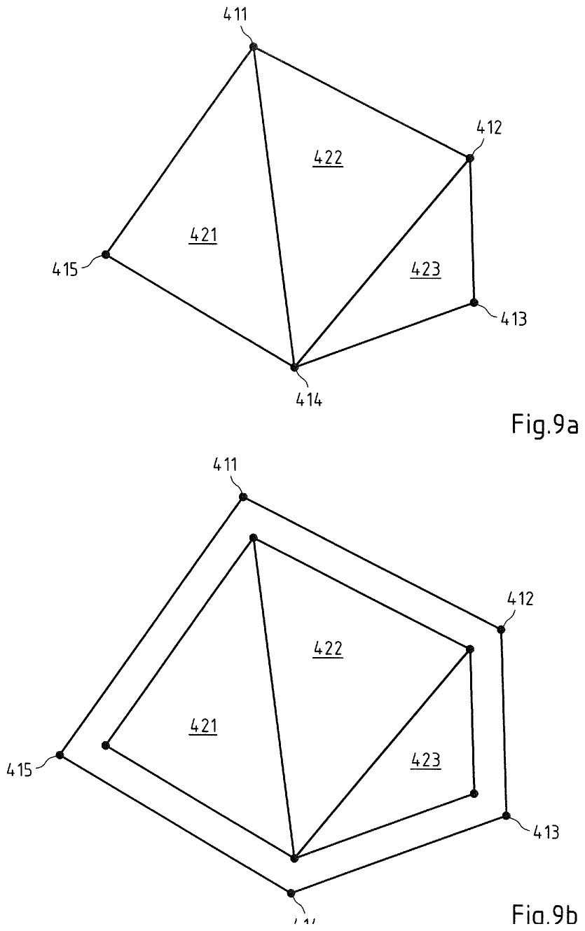

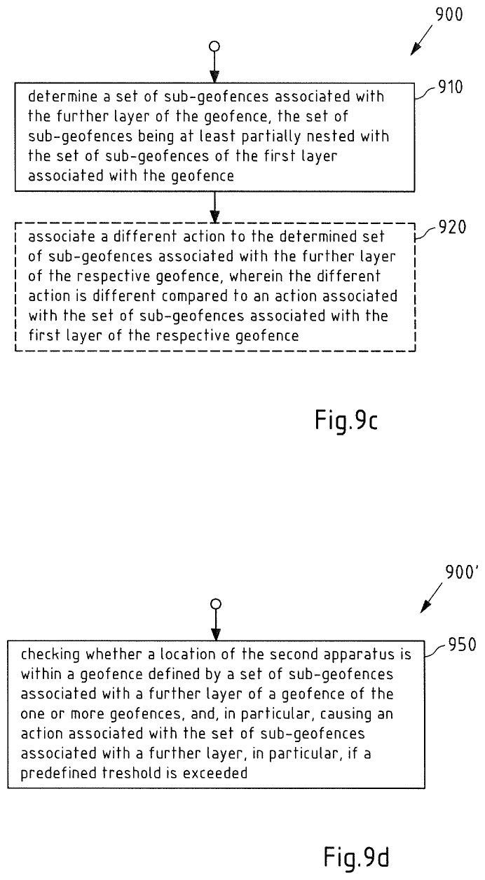

As an example, FIG. 9a shows the geofence 410 known from FIG. 4a, wherein a representation of this geofence 410 may comprises the set of sub-geofences 421, 422, 423 according to the example presented in FIG. 4a. Then, for instance, this representation of geofence 410 comprising the sub-geofences 421, 422, 423 may be considered to be associated with the first layer.

FIG. 9b shows, in addition to geofence 410 a second layer which is associated with the geofence 410. E.g. this second layer comprises a set of sub-geofences at least partially nested with the set of sub-geofences 421, 422, 423 of the first layer of this geofence. For instance, the set of sub-geofences associated with the second layer of geofence 410 may be associated with a different action compared to an action associated with the set of sub-geofences 421, 422, 423 associated with the first layer of said representation of the geofence 410.

For instance, if the geofence 410 is defined by a polygon P1, wherein the set of sub-geofences 421, 422, 423 associated with the first layer of said representation of the geofence 410 define this polygon P1, said set of sub-geofences associated with the second layer of geofence 410 may define a polygon P2 that nests polygon P1, wherein polygon P2 may be larger than polygon P1. Furthermore, as an example, the shape of polygon P2 may be at least substantially the same (or exactly the same) as the shape of polygon P1. Then, as an example, polygon P2 may be divided into the set of sub-geofences associated with the second layer of geofence 410, e.g. by dividing polygon P2 into triangles as explained above.

As an example, different actions could be associated with the set of sub-geofences 421, 422, 423 associated with the first layer of said representation of the geofence 410 and with the set of sub-geofences associated with the second layer of said representation of the geofence 410: E.g., a first action could be associated for a point not being within an area (e.g. area defined by P1) defined by the set of sub-geofences 421, 422, 423 associated with the first layer of said representation of the geofence 410 and being within an area (e.g. area defined by P2) defined by the set of sub-geofences associated with the second layer of said representation of the geofence 410, and/or a second action could be associated for a point within an area (e.g. area defined by P1) defined by the set of sub-geofences 421, 422, 423 associated with the first layer of said representation of the geofence 410, and/or a third action could be associated for a point being outside an area (e.g. are defined by P2) defined by the set of sub-geofences associated with the second layer of said representation of the geofence 410.

For instance, for each layer of the at least one further layer of a representation of a geofence different actions may be associated, wherein an area defined by the set of sub-geofences associated with the respective further layer may represent a polygon Px, and wherein a first action could be associated for a point not being within an area (e.g. area defined by P1) defined by the set of sub-geofences 421, 422, 423 associated with the first layer of said representation of the geofence 410 and being within an area (e.g. area defined by Px) defined by the set of sub-geofences associated with the respective further layer of said representation of the geofence 410, and/or a second action could be associated for a point within an area (e.g. area defined by P1) defined by the set of sub-geofences 421, 422, 423 associated with the first layer of said representation of the geofence 410, and/or a third action could be associated for a point being outside an area (e.g. are defined by Px) defined by the set of sub-geofences associated with the respective further layer of said representation of the geofence 410.

FIG. 9c depicts an example embodiment of a method 900′ according to the second aspect of the invention. Thus, method 900′ may be performed by the at least one apparatus according to the second aspect of the invention, e.g. by apparatus 200 or by apparatus 320.

Method 900 comprises, for a further layer of a geofence of the set at least one geofences, determining a set of sub-geofences associated with the further layer of the respective geofence, the set of sub-geofences being at least partially nested with the set of sub-geofences of the first layer associated with the geofence (action 910).

For instance, as a non-limiting example, if the geofence is defined by a polygon P1, wherein the set of sub-geofences 421, 422, 423 associated with the first layer of said representation of the geofence 410 define this polygon P1, said set of sub-geofences associated with the a further layer of geofence 410 may define a polygon Px that nests polygon P1, wherein polygon Px may be larger than polygon P1. Furthermore, as an example, the shape of polygon Px may be at least substantially the same (or exactly the same) as the shape of polygon P1. Then, as an example, polygon P2 may be divided into the set of sub-geofences associated with the second layer of geofence 410, e.g. by dividing polygon Px into triangles as explained above.

Thus, for instance, a new area defined by the determined by the set of sub-geofences associated with the further layer of the respective geofence can be obtained. As an example, the area may be defined by the above mentioned polygon Px.

As an example, said determining a set of sub-geofences associated with the further layer of the respective geofence in action 910 may be performed based on introducing at least one extra point inside and/or outside an area defined by set of sub-geofences of the first layer of the respective geofence, wherein, in particular, said determining may be performed based on a Delaunay triangulation.

As a first non-limiting example, said at least one extra point outside an area defined by set of sub-geofences of the first layer of the respective geofence may represent a plurality of extra points outside an area defined by set of sub-geofences of the first layer of the respective geofence.

For instance, as exemplarily depicted in FIG. 9b, for a respective further layer extra points 441, 442, 443, 444, 445 may be introduced outside an area defined by the set of sub-geofences 421, 422, 423 and based on these extra points, a set of sub-geofences associated with the further layer can be determined.

As a first non-limiting example, said determining a set of sub-geofences associated with the further layer of the respective geofence in action 910 may be performed based on the plurality of extra points 441, 442, 443, 444, 445 (e.g. without using points 411, 412, 413, 414, 415) outside the area defined by the set of sub-geofences 421, 422, 423, wherein said plurality of extra points defines a polygon Px that nests the polygon (e.g. denoted as P1) defined by the points 411, 412, 413, 414, 415 of the set of sub-geofences 421, 422, 423. Then, based on this polygon Px the set of sub-geofences associated with the further layer of the respective geofence can be determined, e.g. according to the explanations presented with respect to action 510 or 510, e.g. by dividing polygon Px into triangles, wherein each of these triangles represent a sub-geofence of the set of sub-geofences associated with the further layer of the respective geofence.

As a second non-limiting example, said determining a set of sub-geofences associated with the further layer of the respective geofence in action 910 may be performed based on the plurality of extra points 441, 442, 443, 444, 445 and based on at least one point of the 411, 412, 413, 414, 415 of the set of sub-geofences 421, 422, 423 of the first layer of the respective geofence. Then, for instance, a triangulation may be performed based on the plurality of extra points 441, 442, 443, 444, 445 of the respective further layer and based on at least one point of the 411, 412, 413, 414, 415 of the set of sub-geofences 421, 422, 423 of the first layer of the respective geofence in order to determine the set of sub-geofences associated with the respective further layer of the respective geofence in action 910.

E.g., said determining a set of sub-geofences associated with the further layer of the respective geofence in action 910 may be performed based on a user action, e.g. similar to or as explained with respect to action 610. For instance, said user interaction may be performed with apparatus 200 or apparatus 320 and may be performed via a user interface of the apparatus 200 or apparatus 320, or via a network that that the user may connect with a user's device with apparatus 200 or apparatus 320. Based on the user interaction, the user may define the further layer of the geofence, e.g. by defining said at least one extra point inside and/or outside an area defined by set of sub-geofences of the first layer of the respective geofence.

Furthermore, method 900 may comprise an optional action 920 which comprises associating a different action to the determined set of sub-geofences associated with the further layer of the respective geofence (determined by action 910), wherein the different action is different compared to an action associated with the set of sub-geofences associated with the first layer of the respective geofence. Accordingly, different actions may be associated with different layers associated with a representation of geofence 410. For instance, said different action associated with the determined set of sub-geofences associated with the further layer of the respective geofence may be determined based on the above mentioned user interaction.

As an example, method 900 may be performed for a selected at least one geofence of the set of at least one geofence, wherein for each geofence of the selected at least one geofence at least one further layer may be associated, and wherein action 910 is and optional action 920 may be performed for each layer of the at least one further layer associated with the respective geofence of the selected at least one geofence. Thus, for instance, method 900 may be used for, for each geofence of at least one geofence (said at least one geofence may represent the above mentioned selected at least one geofence) of the set of at least one geofence, and for each layer of a further layer associated with the respective geofence: (i) determining a set of sub-geofences being at least partially nested with the set of sub-geofences of the first layer associated with the respective geofence; and, in particular, (ii) associating a different action to the determined set of sub-geofences compared to an action associated with the set of sub-geofences associated with the first layer the respective geofence.

FIG. 9d depicts an example embodiment of a method 900′ according to the first aspect of the invention. Thus, method 800′ may be performed by the at least one apparatus according to the first aspect of the invention which may be considered to represent the second apparatus, e.g. by apparatus 100 or by apparatus 310.

In action 950 of method 900′ it is checked whether a location of the second apparatus is within a geofence defined by a set of sub-geofences associated with a further layer of a geofence of the one or more geofences. For instance, said location may be determined as explained with respect to action 810 or action 840, and said checking whether location of the second apparatus is within a geofence defined by a set of sub-geofences associated with a further layer of a geofence of the one or more geofences may be performed in a same way as said checking whether a location is within a geofence defined by a representation of a geofence of the one or more geofences in action 810 or in action 840 explained with respect to the set of sub-geofences (of the first layer) of the respective geofence.

For instance, said check in action 950 may be performed for each geofence of the one or more geofences which is associated with at least one further layer, wherein it may be checked for each layer of the at least one further layer of the respective geofence whether a location of the second apparatus is within an area defined by a set of sub-geofences associated with the respective further layer of the respective geofence.

As an example, if said checking whether a location of the second apparatus is within a geofence defined by a set of sub-geofences associated with a further layer of a geofence of the one or more geofences yields a positive result, action 950 may comprise causing an action associated with the set of sub-geofences associated with the further layer of the respective geofence. For instance, said action associated with the set of sub-geofences associated with the further layer of the respective geofence may represent a different action associated to this set of sub-geofences associated with the further layer of the respective geofence in optional action 920 of method 900.

Accordingly, as an example, an arbitrary number of nested geofence areas with differing actions/attributes may be generated. Furthermore, to the different layer of a geofence different types of resolutions of a geofence may be achieved.

As an example, said optional causing an action associated with the set of sub-geofences associated with the further layer of the respective geofence in action 950 may be performed if at least one predefined threshold is exceeded. For instance, the at least one predefined threshold may define a number of times (e.g. 3 times, or 4 time, or 5 times, or any other well-suited number of times) a current position must be located within an area defined by the set of sub-geofences associated with the further layer of the respective geofence within a predetermine time interval (e.g. 30 second, 1 minute, 2 minutes, 5 minutes, or any other well-suited time interval),

Furthermore, for instance, said method 900′ may be performed together with method 800 or method 800′ such that it can be checked whether a location (e.g. of the second apparatus 100, 310) is within a sub-geofences of a set of sub-geofences associated with a layer (e.g. the first layer and/or one of the at least one further layer) associated with a geofence of the one or more geofences.

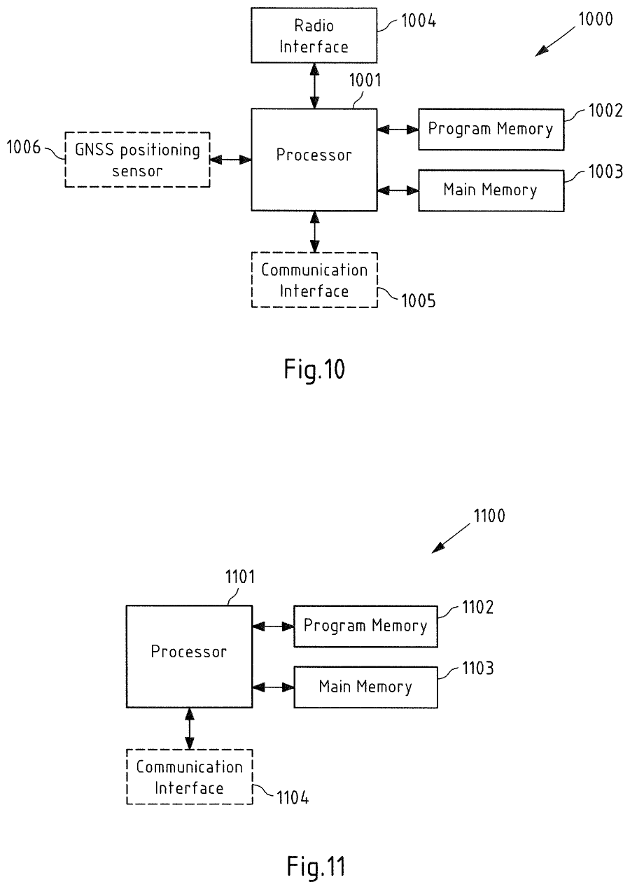

FIG. 10 is a block diagram of an exemplary embodiment of an apparatus in form of a mobile device 1000 according to the first aspect of the invention. For instance, the mobile device 1000 may be any of the previously mentioned apparatuses according to the first aspect of the invention, e.g. apparatus 100 and/or 310, 310, and, in particular, apparatus 1000 may be a mobile device and/or movable device, e.g. which may be used for geofencing. Furthermore, and/or, as an example, mobile device 1000 may be configured to perform any of the method 100′, 700, 800, 800′, 900′. For example, mobile device 1000 may be one of a smartphone, a tablet computer, a notebook computer, a smart watch and a smart band. For instance, mobile device 1000 may be considered to be part or at least carried by a vehicle, e.g. a car or a truck or any other well-suited vehicle.

Mobile device 1000 comprises a processor 1001. Processor 1001 may represent a single processor or two or more processors, which are for instance at least partially coupled, for instance via a bus. Processor 1001 executes a program code stored in program memory 1002 (for instance program code causing mobile device 1000 to perform one or more of the embodiments of a method according to the invention or parts thereof (e.g. the method or parts of the method described below with reference to FIGS. 1b, 7a, 8a, 8b, and 9d), when executed on processor 1001), and interfaces with a main memory 1003. Program memory 1002 may also contain an operating system for processor 1001. Some or all of memories 1002 and 1003 may also be included into processor 1001.

One of or both of a main memory and a program memory of a processor (e.g. program memory 1002 and main memory 1003 and/or program memory 1002 and main memory 1003 as described below with reference to FIG. 11) could be fixedly connected to the processor (e.g. processor 1001 and/or processor 1101) or at least partially removable from the processor, for instance in the form of a memory card or stick.

A program memory (e.g. program memory 1002 and/or program memory 1102 as described below with reference to FIG. 9) may for instance be a non-volatile memory. It may for instance be a FLASH memory (or a part thereof), any of a ROM, PROM, EPROM, MRAM or a FeRAM (or a part thereof) or a hard disc (or a part thereof), to name but a few examples. For example, a program memory may for instance comprise a first memory section that is fixedly installed, and a second memory section that is removable from, for instance in the form of a removable SD memory card.

A main memory (e.g. main memory 1003 and/or main memory 1103 as described below with reference to FIG. 11) may for instance be a volatile memory. It may for instance be a DRAM memory, to give non-limiting example. It may for instance be used as a working memory for processor 1001 when executing an operating system and/or programs.

Processor 1001 further controls a radio interface 1004 configured to receive and/or output data and/or information. For instance, radio interface 1004 may be configured to receive radio signals from a radio node. The radio interface 1004 is configured to scan for radio signals that are broadcast by radio nodes, e.g. based an WiFi (WLAN) or a Bluetooth or any other radio communications system (e.g. a cellular radio communication system like 2G, 3G, 4G, 5G). Furthermore, the radio interface 1004 may be configured for evaluating (e.g. taking measurements on the received radio signals like measuring a received signal strength) and/or extracting data or information from the received radio signals. It is to be understood that any computer program code based processing required for receiving and/or evaluating radio signals may be stored in an own memory of radio interface 1004 and executed by an own processor of radio interface 1004 or it may be stored for example in memory 1003 and executed for example by processor 1001. Thus, said radio interface 1004 may be configured to support at least one positioning technology of the one or more positioning technologies according to the first and/or second aspect of the invention, wherein the positioning technology is configured to estimate the location of the mobile device 1000 based on a radio map, which may be stored in main memory 1003 or program memory 1002 of the mobile device 1000. This positioning technology may be configured to perform offline positioning, e.g. as explained before. For instance, the radio map may be received by the mobile device 1000 by means of a transmission caused in action 750 of method 700″. Mobile device 1000 may use radio interface 1005 to communicate with a server, e.g. with the server 1100 depicted in FIG. 11 or with any at least one apparatus according to the second aspect of the invention, e.g. apparatus 100 or 320, .g. via network 340.

For example, the radio interface 1004 may for instance at least comprise a BLE and/or Bluetooth radio interface including at least a BLE receiver (RX). The BLE receiver may be a part of a BLE transceiver. It is to be understood that the invention is not limited to BLE or Bluetooth. For example, radio interface 204 may additionally or alternatively comprise a WLAN radio interface including at least a WLAN receiver (RX). The WLAN receiver may also be a part of a WLAN transceiver.

Moreover, for instance, processor 1001 may control a further communication interface 1005 which is for example configured to communicate according to a cellular communication system like a 2G/3G/4G/5G cellular communication system. Mobile device 1000 may use communication interface 1005 to communicate with a server, e.g. with the server 1100 depicted in FIG. 11 or with any at least one apparatus according to the second aspect of the invention, e.g. apparatus 100 or 320, e.g. via network 340. Thus, as an example, said further communication interface 1005 may be configured to support at least one positioning technology of the one or more positioning technologies according to the first and/or second aspect of the invention.

Furthermore, processor 1001 may control an optional GNSS positioning sensor 1006 (e.g. a GPS sensor or any other GNSS positioning techniques previously mentioned). GNSS positioning sensor may be configured to receive satellite signals of a GNSS system (e.g. GPS satellite signals) and to determine a position of the mobile device (e.g. a current position of the mobile device) at least partially based on satellite signals of the GNSS system that are receivable at this position. Said GNSS positioning sensor may be configured to support one or more positioning technology of the one or more positioning technologies according to the first and/or second aspect of the invention.

The components 1002 to 1006 of mobile device 1000 may for instance be connected with processor 1001 by means of one or more serial and/or parallel busses.

It is to be understood that mobile device 1000 may comprise various other components. For example, mobile device 1000 may optionally comprise a user interface (e.g. a touch-sensitive display, a keyboard, a touchpad, a display, etc.) or one or more inertial sensors (e.g. an accelerometer, a gyroscope, a magnetometer, a barometer, etc.).

For instance, said mobile device 1000 may process the geofence and may track its position in order to provide a notification when the mobile device is within the boundaries (e.g. within an area) of a geofence.

FIG. 11 is a block diagram of an exemplary embodiment of a server 1100 according to the second aspect of the invention, which may be a server 1100 in a positioning support system.

As an example, server 1100 may represent at least one apparatus according to the second aspect of the invention, e.g. apparatus 200 or apparatus 320.

For instance, said server 1100 may be configured to perform any of the methods 200′, 500, 500′, 600, 700′, 700″ and 900.

Server 1100 comprises a processor 1101. Processor 1101 may represent a single processor or two or more processors, which are for instance at least partially coupled, for instance via a bus. Processor 1101 executes a program code stored in program memory 1102 (for instance program code causing server 1100 to perform one or more of the embodiments of a method according to any of the aspects of the invention or parts thereof (e.g. the method or parts of the method described below with reference to FIG. 2a, 5a, 5b, 6, 7b, 7c or 9c, when executed on processor 1101), and interfaces with a main memory 1103.

Program memory 1102 may also comprise an operating system for processor 1101. Some or all of memories 1102 and 1103 may also be included into processor 1101.

Moreover, processor 1101 controls a communication interface 1104 which is for example configured to communicate according to a cellular communication system like a 2G/3G/4G/5G cellular communication system or according to another communication system. Server 1100 may use communication interface 1104 to communicate with an apparatus according to the first aspect of the invention, e.g. apparatus 100, 310, 310′ or mobile device 1000, e.g. via network 340. Furthermore, it has to be understood that this communication interface 1104 may be used to perform transmission 350, 350′ via a cellular communication system like a 2G/3G/4G/5G cellular communication system (and for example including the Internet) to the apparatus according to the first aspect of the invention, e.g. via the communication interface 1005 of the mobile device 1000, and/or that that this communication interface 1104 may be used to perform transmission 350, 350′ e.g. via the Internet and via the Radio Interface 1004 of the mobile device 100 to the apparatus according to the first aspect of the invention.

The components 302 to 304 of server 1100 may for instance be connected with processor 1101 by means of one or more serial and/or parallel busses.

It is to be understood that server 1100 may comprise various other components. For example, server 1100 may optionally comprise a user interface (e.g. a touch-sensitive display, a keyboard, a touchpad, a display, etc.). For instance, said user interface may be configured to receive a user interaction for determining geofence(s) by method 600 (e.g. action 610) and/or by method 900 (e.g. action 910 and optional action 920). And/or, said user interaction may be performed via the communication interface 1104 of the server 1100.

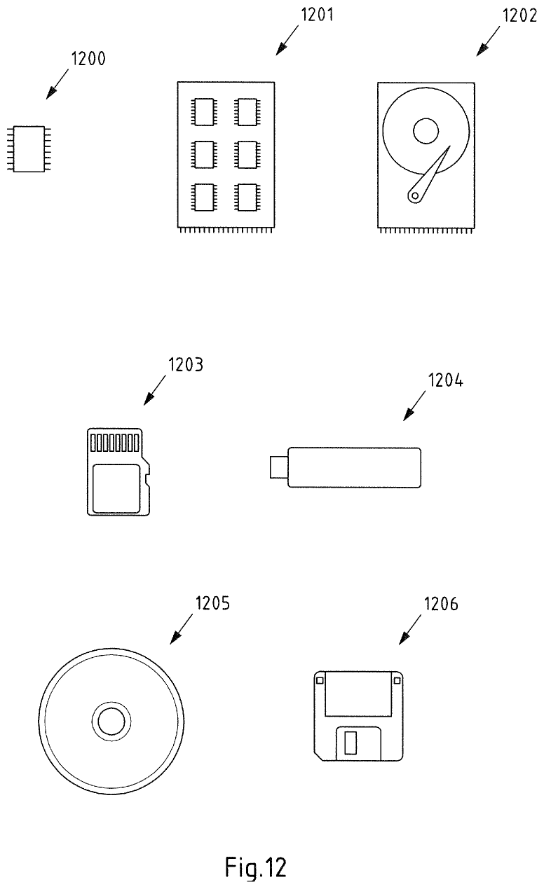

FIG. 12 is a schematic illustration of examples of tangible and non-transitory computer-readable storage media according to the present invention that may for instance be used to implement program memory 102 of FIG. 1a, or program memory 202 of FIG. 2a, or memory 1002 of FIG. 10 or memory 1102 of FIG. 11. To this end, FIG. 10 displays a flash memory 1100, which may for instance be soldered or bonded to a printed circuit board, a solid-state drive 1101 comprising a plurality of memory chips (e.g. Flash memory chips), a magnetic hard drive 1102, a Secure Digital (SD) card 1103, a Universal Serial Bus (USB) memory stick 1104, an optical storage medium 1105 (such as for instance a CD-ROM or DVD) and a magnetic storage medium 1106.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)

(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and

(c) to circuits, such as a microprocessor(s) or a portion of a microprocessor(s), that re-quire software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text, in particular but not limited to processors 101, 201, 1001 and 1101 of FIGS. 1a, 2a, 10 and 11, could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The wording “A, or B, or C, or a combination thereof” or “at least one of A, B and C” may be understood to be not exhaustive and to include at least the following: (i) A, or (ii) B, or (iii) C, or (iv) A and B, or (v) A and C, or (vi) B and C, or (vii) A and B and C.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an example embodiment in a particular category may also be used in a corresponding manner in an example embodiment of any other category.

1. A method performed by an apparatus, said method comprising:
receiving a representation of a geofence for each geofence of one or more geofences from a server via a network, wherein the representation of a geofence comprises a set of sub-geofences, and wherein the sub-geofences of a set of sub-geofences represent splitted components of the geofence associated with the set of sub-geofences.

2. The method according to claim 1, wherein a sub-geofence of a set of sub-geofences has less geometrical complexity compared to the geometrical complexity of the geofence associated with the set of sub-geofences.

3. The method according to claim 1, wherein the geofence associated with a set of sub-geofences is defined at least partially based on a polygon of order m, and wherein a sub-geofence of the set of sub-geofences associated with the geofence is defined by a polygon of order n, with n<m.

4. The method according to claim 1, wherein each sub-geofence of a set of sub-geofences is defined by a triangle.

5. The method according to claim 1, wherein the sub-geofences of a set of sub-geofences do not overlap with each other.

6. The method according to claim 1, comprising receiving a radiomap from a server via the network, wherein, in particular receiving a representation of a geofence for each geofence of one or more geofences from a server via a network and said receiving a radiomap from the server via the network is performed during a same transmission session.

7. The method according to claim 6, wherein the radiomap is an offline radiomap.

8. The method according to claim 6, wherein the at least one representation of a geofence is within an area defined by the radio map.

9. The method according to claim 6, comprising, before said receiving a representation of a geofence for each geofence of one or more geofences from a server via a network, causing the transmission of a geofence request to the server via the network, wherein, in particular, the geofence request comprises at least one parameter, and wherein the at least one parameter comprises a location information and/or an information regarding storage size.

10. The method according to claim 1, comprising:
checking whether a location of the apparatus is within a geofence defined by a representation of a geofence of the one or more geofences.

11. The method according to claim 10, wherein said checking whether a location of the apparatus is within a geofence defined by a representation of a geofence of the one or more geofences comprises checking if the location is within in a sub-geofence of the set of sub-geofences associated with the geofence.

12. The method according to claim 10, wherein said checking whether a location of the apparatus is within a geofence defined by a representation of a geofence of the one or more geofences is performed based on barycentric coordinates.

13. The method according of claim 10, comprising determining the location based on a radio map, in particular said radio map received from a server via the network.

14. The method according to claim 1, wherein said set of sub-geofences of a representation of a geofence for each geofence of the one or more geofences of the set of at least one geofence is associated with a first layer, and wherein for each geofence of at least one geofence of the one or more geofences the geofence is associated with at least one further layer, wherein each layer of the at least one further layer associated with the geofence comprises a set of sub-geofences being at least partially nested with the set of sub-geofences of the first layer associated with the geofence; wherein, in particular, each layer of the at least one further layer associated with the geofence is part of the representation of a geofence.

15. The method according to claim 14, wherein a set of sub-geofences associated with a further layer of a geofence is associated with a different action compared to an action associated with the set of sub-geofences associated with the first layer of the geofence.

16. The method according to claim 14, comprising:
checking whether a location of the second apparatus is within a geofence defined by a set of sub-geofences associated with a further layer of a geofence of the one or more geofences, and, in particular, causing an action associated with the set of sub-geofences associated with a further layer, in particular, if at least one predefined threshold is exceeded.

17. (canceled)

18. (canceled)

19. An apparatus comprising at least on processor and at least on memory including computer program code, the at least one memory and the computer program code configured to, with the at least one processor, cause an apparatus to:
receive a representation of a geofence for each geofence of one or more geofences from a server via a network, wherein the representation of a geofence comprises a set of sub-geofences, and wherein the sub-geofences of a set of sub-geofences represent splitted components of the geofence associated with the set of sub-geofences.

20. A method performed by a first apparatus, the method comprising:
causing the transmission of a representation of a geofence for each geofence of one or more geofences of a set of at least one geofence to a second apparatus via a network, wherein the representation of a geofence comprises a set of sub-geofences, and wherein the sub-geofences of a set of sub-geofences represent splitted components of the geofence associated with the set of sub-geofences.

21-40. (canceled)

41. The apparatus according to claim 19, wherein a sub-geofence of a set of sub-geofences has less geometrical complexity compared to the geometrical complexity of the geofence associated with the set of sub-geofences.

42. The apparatus according to claim 19, wherein the geofence associated with a set of sub-geofences is defined at least partially based on a polygon of order m, and wherein a sub-geofence of the set of sub-geofences associated with the geofence is defined by a polygon of order n, with n<m.

43. The apparatus according to claim 19, wherein the at least one memory and the computer program code are further configured to, with the at least one processor, cause the apparatus to receive a radiomap from a server via the network during a same transmission session in which the representation of the geofence for each geofence of one or more geofences is received from a server via the network.
